(19) United States
(12) Patent Application Publication
(10) Pub. No.: US 2025/0254180 A1
(43) Pub. Date: Aug. 7, 2025

(54) SYSTEMS, METHODS, AND APPARATUS FOR MESH ATTESTATION VERIFICATION

(71) Applicant: Intel Corporation, Santa Clara, CA (US)

(72) Inventor: Ned M. Smith, Beaverton, OR (US)

(73) Assignee: Intel Corporation, Santa Clara, CA (US)

(21) Appl. No.: 19/041,567

(22) Filed: Jan. 30, 2025

Related U.S. Application Data
(60) Provisional application No. 63/627,033, filed on Jan. 30, 2024.

(51) Int. Cl. H04L 9/40

(52) U.S. Cl. CPC H04L 63/12; H04L 63/20

(57) ABSTRACT

Systems, apparatus, articles of manufacture, and methods are disclosed that provide mesh attestation verification. At least one non-transitory machine-readable medium includes machine-readable instructions to cause at least one processor circuit to at least: obtain an attestation input including an accepted claims set (ACS) of a verifier mesh and attestation evidence indicative of a claimed operating state of an attester, the verifier mesh including a plurality of verifiers; update the ACS based on the attestation evidence; and cause the ACS to be transmitted to the plurality of verifiers in the verifier mesh.

### RELATED APPLICATION

This patent claims the benefit of U.S. Provisional Patent Application No. 63/627,033, which was filed on Jan. 30, 2024. U.S. Provisional Patent Application No. 63/627,033 is hereby incorporated herein by reference in its entirety. Priority to U.S. Provisional Patent Application No. 63/627,033 is hereby claimed.

### BACKGROUND

In secure networks, network nodes may provide proof of their identity and trustworthiness to other nodes within the network using attestation and verification procedures. Additionally, attestation may be used to assert a security state of a node. Verification is the process of confirming the truth of the assertions made by the attesting node.

### BRIEF DESCRIPTION OF THE DRAWINGS

FIG. 1 is a block diagram of an example environment in which an example verifier operates to generate attestation results.

FIG. 2 is an example verifier mesh that may implement the verifier of FIG. 1.

FIG. 3 is s block diagram of an example mesh circuitry to implement the verifiers of the verifier mesh of FIG. 2

FIG. 4 is an example verifier mesh utilizing distributed ledger technology (DLT) to manage ACS state change.

FIG. 5 is a block diagram illustrating condition processing implemented by the mesh verifier circuitry of FIG. 3.

FIG. 6 is a block diagram illustrating ACS view processing based on a centralized ACS implemented by the mesh verifier circuitry of FIG. 3.

FIG. 7A is a flowchart representative of example machine readable instructions and/or example operations that may be executed, instantiated, and/or performed by programmable circuitry to generate attestation results for a relying party.

FIG. 7B is a flowchart representative of example machine readable instructions and/or example operations that may be executed, instantiated, and/or performed by programmable circuitry to generate attestation results for a relying party.

FIG. 8 is a conceptual diagram illustrating an example attester system.

FIG. 9 is a flowchart representative of example machine readable instructions and/or example operations that may be executed, instantiated, and/or performed by example programmable circuitry to implement the mesh verifier circuitry of FIG. 3.

FIG. 10 is a flowchart representative of example machine readable instructions and/or example operations that may be executed, instantiated, and/or performed by example programmable circuitry to implement the mesh verifier circuitry of FIG. 3.

FIG. 11 is a conceptual diagram illustrating a combination of bottom-up and top-down description of another example attester system 600.

FIG. 12 is a conceptual diagram illustrating an example combined network of nodes generated by the mesh verifier circuitry of FIG. 3.

FIG. 13 is a block diagram of an example processing platform including programmable circuitry structured to execute, instantiate, and/or perform the example machine readable instructions and/or perform the example operations of FIGS. 7A, 7B, 9, and 10 to implement the mesh verifier circuitry of FIG. 3.

FIG. 14 is a block diagram of an example implementation of the programmable circuitry of FIG. 13

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine readable instructions of FIGS. 7A, 7B, 9, and 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 17 illustrates example endorsements provided by an endorser for an attester for an example static composition, direct enforcement use case.

FIG. 18 illustrates an example ACS generated by the mesh verifier circuitry of FIG. 3 for an attester for the example static composition, direct enforcement use case of FIG. 17.

FIG. 19 illustrates example endorsements provided by an endorser for an attester and example attestation evidence from the attester for an example evidence matching use case.

FIG. 20 illustrates an example ACS generated by the mesh verifier circuitry of FIG. 3 for an attester for the example evidence matching use case of FIG. 19.

FIG. 21 illustrates an example NIC ACS generated by the mesh verifier circuitry of FIG. 3 for a NIC of an attester for an example simple endorsement use case.

FIG. 22 illustrates an example ACS generated by the mesh verifier circuitry of FIG. 3 for an attester for the example simple endorsement use case of FIG. 21.

FIG. 23 illustrates example endorsements from an OEM manufacturer, example endorsements and reference values from a motherboard manufacturer, example attestation evidence from a first attester, and example attestation evidence from a second attester for an example update and patch use case.

FIG. 24 illustrates an example ACS generated by the mesh verifier circuitry of FIG. 3 for an attester for the example update and patch use case of FIG. 23.

FIG. 25 illustrates example endorsements and reference values provided by a NIC manufacturer for a NIC of an attester and attestation evidence provided by the attester for an example dynamic composition use case.

FIG. 26 illustrates an example ACS generated by the mesh verifier circuitry of FIG. 3 for an attester for the example dynamic composition use case of FIG. 15.

FIG. 27 illustrates an example NIC ACS generated by the mesh verifier circuitry of FIG. 3 for a NIC of an attester for an example conditional endorsement use case.

FIG. 28 illustrates an example ACS generated by the mesh verifier circuitry of FIG. 3 for an attester for the example conditional endorsement use case of FIG. 27.

FIG. 29 illustrates an example NIC ACS generated by the mesh verifier circuitry of FIG. 3 for a NIC of an attester for an example conditional endorsement series use case.

FIG. 30 illustrates an example ACS generated by the mesh verifier circuitry of FIG. 3 for an attester for the example conditional endorsement series use case of FIG. 29.

FIG. 31 illustrates an example NIC ACS generated by the mesh verifier circuitry of FIG. 3 for a NIC of an attester for an example multi-endorsement use case.

FIG. 32 illustrates an example ACS generated by the mesh verifier circuitry of FIG. 3 for an attester for the example multi-endorsement use case of FIG. 31.

FIG. 33 illustrates an example NIC ACS generated by the mesh verifier circuitry of FIG. 3 for a NIC of an attester for an example conditional endorsement with authority use case.

FIG. 34 illustrates an example ACS generated by the mesh verifier circuitry of FIG. 3 for an attester for the example conditional endorsement with authority use case of FIG. 33.

FIG. 35 illustrates example endorsements and reference values provided by an independent software vendor (ISV) for software of an attester and attestation evidence provided by the attester for an example concise SWID (CoSWID) matching use case.

FIG. 36 illustrates an example ACS generated by the mesh verifier circuitry of FIG. 3 for an attester for the example CoSWID matching use case of FIG. 35.

FIG. 37 illustrates an example ACS generated by the mesh verifier circuitry of FIG. 3 for an attester after the verifier circuitry stages shown in FIGS. 17-36.

FIG. 38 illustrates an example application of an appraisal policy to an ACS by the mesh verifier circuitry of FIG. 3.

FIG. 39 illustrates an example ACS generated by the mesh verifier circuitry of FIG. 3 for an attester after application of an appraisal policy.

FIG. 40 illustrates example verifier asserted claims generated by the mesh verifier circuitry of FIG. 3

FIG. 41 illustrates an example final ACS generated by the mesh verifier circuitry of FIG. 3 for an attester in a final state.

FIG. 42 is an example system with appraisal contexts.

FIG. 43 is a block diagram of another example environment in which the mesh verifier circuitry of FIG. 3 operates to generate attestation results.

FIG. 44 is a block diagram illustrating attestation results utilizing attester compositional context.

FIG. 45 illustrates the CAR schema in concise data definition language (CDDL).

FIG. 46 is an example ACS generated by the verifier mesh circuitry of FIG. 2 as a common oracle for multiple attestation formats.

FIG. 47 is an example ACS with example transition stages to ensure processing accuracy and consistency.

In general, the same reference numbers will be used throughout the drawing(s) and accompanying written description to refer to the same or like parts. The figures are not necessarily to scale.

### DETAILED DESCRIPTION

In trusted computing, attestation is the process of determining whether and how much another system can be trusted. Whether a system can be trusted is a determination that may be made by a relying party or a trusted intermediary based on relevant information, such as the initial operating states of the system. A trusted system is one that is determined to be able to perform intended functions without compromising the security of sensitive information, without performing malicious acts, or without other security compromises. In some environments, only trusted systems are allowed access to data or certain network privileges. Systems that fail to prove they are trustworthy can be denied access, flagged as untrustworthy, or otherwise quarantined. In an example arrangement, a first system (e.g., an attester, attester device) that wants to access sensitive data and/or gain certain privileges produces information about itself (e.g., attestation evidence, attestation data, etc.), including claims about the operating state of the attester, to enable a second system (e.g., a relying party, relying device) to evaluate the trustworthiness of the first system. This process can be facilitated by an additional party (e.g., a verifier) that appraises evidence according to a set of rules (e.g., appraisal policies) and produces attestation results to the relying party. The verifier relies on endorsements (e.g., expected or intrinsic states) about the attester device and compares the attestation evidence with reference values according to the appraisal policies. If the comparison satisfies the verifier, the verifier accepts the initial claims made by the attester device, then the accepted claims may be used to evaluate additional attestation evidence produced by the attester device to further augment the accepted claims. An endorsement is a secure statement from a third-party vouching for the integrity of the attester device and its attestation capabilities. Reference values and endorsements are typically provided by a manufacturer of a component on the attester device that generated the attestation evidence.

Attestation evidence (e.g., attestation data, etc.), reference values, and endorsements may exist in a variety of formats including manifests, tokens, and certificates (e.g., extensible markup language (XML), HyperText Markup Language (HTML), Concise Binary Object Representation (CBOR) Web token (CWT), JavaScript Object Notation (JSON) Web Token (JWT), Security Protocols and Data Models (SPDM), Entity Attestation Token (EAT), Abstract Syntax Notation One (ASN.1), Open Policy Agent (OPA)/REGO, binary, etc.). Attestation evidence associated with the various formats follows a schema or convention that defines how to relate evidence with reference values and endorsements with accepted claims. Example schemas/conventions include Software Identification (SWID) Tagging, Concise Reference Integrity Manifest (CoRIM), Trusted Platform Module (TPM), X.509, and Trusted Computing Group (TCG) Platform Certificate.

Standardized attestation message formats and schemas may be utilized to make it reasonable for verifiers to know the syntax and semantics of attestation information. However, using standardized attestation messages does not guarantee that verifier results will be consistent since different attestation information can come to light at different times and in different sequences. Such variation can result in verifiers producing inconsistent results. Furthermore, some known verification and attestation systems utilize a centralized verifier to compile and verify attestation evidence proffered by network nodes. Centralized verifiers may be a single (or relatively limited) point of failure for the trusted computing network. Furthermore, centralized verifiers contribute to system inefficiencies as the scale of the network increases. In some networks without a central authority figure, a centralized verifier cannot be implemented.

Systems, methods, and apparatus disclosed herein enable a distributed system of verifiers (also known as a verifier mesh, a mesh of verifiers) to cooperatively contribute attestation information to an Accepted Claims Set (ACS) without concern for timing and/or ordering of the attestation information. As used herein, an ACS is a log of records representing the operating state of an attester device, each record including: a context-a tuple consisting of an ACS condition and a claimset that is to be appended to the ACS if the condition matches; an authority-the identity of the entity that asserted (provided) the record; and the type of attestation information asserted (for example: Evidence (EV), Reference Values (RV), Endorsements (EN), etc. . . . ). The number nodes performing verification (referred to herein as verifier nodes or verifiers) can grow or shrink dynamically to accommodate workload demand cycles. Example verifier meshes utilize a synchronized clock and timing windows for obtaining attestation information to ensure verifiers do not receive additional/different attestation information outside the bounds of the timing windows, which can lead to inconsistent generation of attestation results. A processing method for attestation information described herein enables an append-only representation of attestation information that may be input from any of the various input entities: attesters, suppliers, appraisal policy owners, or relying parties. Some example verifier meshes disclosed herein utilize distributed ledger technology (DLT) to create a common but decentralized representation of the ACS or any other representation of the state of a target environment or component; which is a stateful model of the various attestation information inputs to a verifier. Example verifier meshes disclosed herein perform periodic synchronization of ACSs generated by individual verifiers within the verifier mesh. Systems, methods, and apparatus disclosed herein generates ACSs for use as a content-defined network (CDN) to enable generation of attestation results for a relying party based on an appraisal policy of the relying party. Entries in an ACS may contain vendor or organization specific customizations where a profile defines these customizations and a profile identifier accompanies the ACS entry.

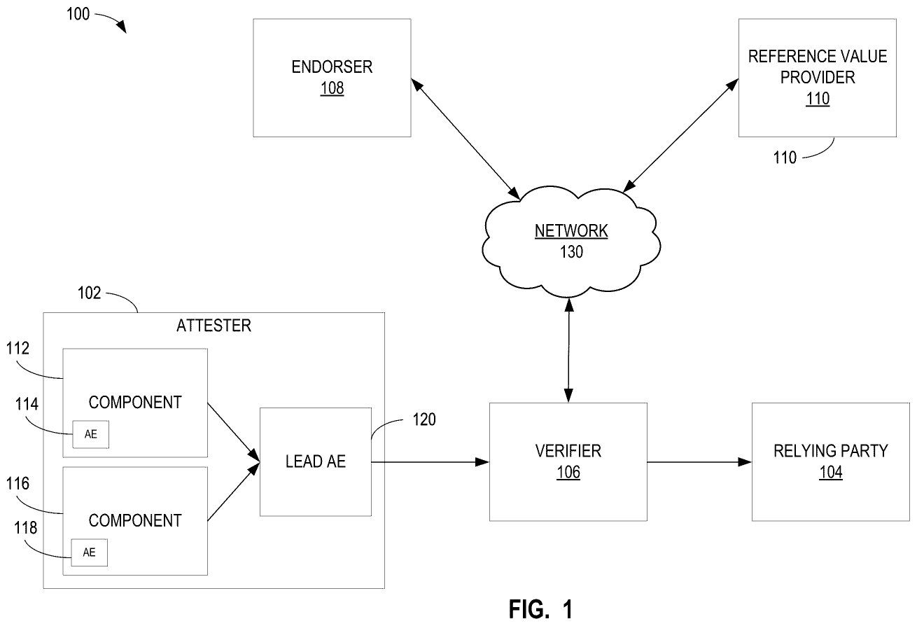

FIG. 1 is a block diagram of an example environment 100 in which example verifier meshes disclosed herein operate to generate attestation results. The example environment 100 includes an example attester 102, an example relying party 104, the example verifier 106, an example endorser 108, an example reference value provider 110, and an example network 130.

The example attester 102 is a computing device such as a server, a personal computer, a workstation, a mobile device, or any other type of computing device. In some examples, the attester 102 is an application executed on a computing device. The example attester 102 includes an example first component 112 having an example first attesting environment 114, a second component 116 having a second attesting environment 118, and an example attestation compiler 120. A component is a functional building block of the attester, such as a CPU, a network interface card (NIC), etc. In some examples, the attester 102 includes more (e.g., three, four, etc.) or fewer (e.g., one) components. An attesting environment (AE) is component measurement collection capabilities and signing capabilities of a component of the attester 102. In some examples, the attester 102 does not include an attestation compiler 120. In some examples, the attester 102 includes more than one attestation compiler 120 and/or more than one connection to the verifier 106. In some examples, the attestation compiler 120 is implemented by one of the attesting environments 114-118.

The example attester 102 generates attestation evidence about itself to enable the relying party 104 to evaluate the trustworthiness of the attester 102. The attestation evidence includes claims about the operating state of the attester 102. In the illustrated example of FIG. 1, the first and second attesting environments 114, 118 generate the attestation evidence about the components of the attester 102. The attester 102 sends the attestation evidence to the verifier 106. In the example of FIG. 1, the first and second attesting environments 114, 118 send the attestation evidence to the attestation compiler 120. The attestation compiler 120 aggregates the attestation evidence and sends the attestation evidence to the verifier 106. In some examples, the attester 102 does not include an attestation compiler 120. In those examples, the attesting environments 114-118 send the attestation evidence directly to the verifier 106.

The example relying party 104 is network equipment (such as a router, switch, or an access point). In some examples, the relying party is a computing device, a website or a mobile application, a server or a service, an entity, an application, and/or any other device or entity that controls access to sensitive data and/or privileges.

The example relying party 104 makes a determination of the trustworthiness of the attester 102 based on the evidence offered by the attester 102, reference values, and endorsements. The relying party 104 makes a decision to allow (e.g., grant, permit, etc.) access to sensitive data or privileges to the attester 102 based on the determination of trustworthiness of the attester 102. In the illustrated example of FIG. 1, the relying party 104 makes the determination of the trustworthiness of the attester 102 based on attestation results generated by the verifier 106 and a set of rules (e.g., attestation results appraisal policy) for evaluating attestation results. In some examples, the attestation results appraisal policy is provided by an owner of the relying party 104. In some examples, the relying party 104 provides the attestation results appraisal policy to the verifier 106 to communicate a desired format or desired content of attestation results.

The example verifier 106 may be implemented by verifier mesh architectures discussed below. In the illustrated example of FIG. 1, the verifier 106 is communicatively connected to the attester 102 and the relying party 104 directly, and the endorser 108 and the reference value provider 110 via the network 130. However, although in the example of FIG. 1, the verifier 106 obtains the endorsements from the endorser 108 and the reference values from the reference value 110 via the network 130, other communicative pathways can be used to transmit the data. For example, in some examples, the verifier 106 can directly access databases of the endorser 108 and the reference value provider 110 and/or (e.g., directly) receive the endorsements from the endorser 108 and the reference values from the reference value provider 110. In some examples, the verifier 106 is a trusted computing environment on the attester 102. In some examples, the verifier 106 is implemented by the relying party 104.

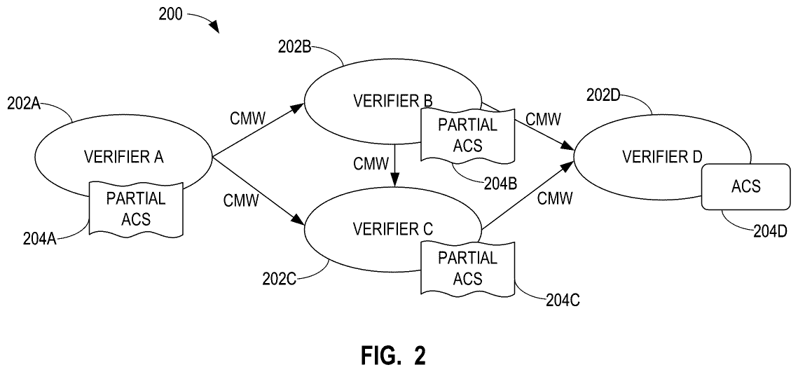

FIG. 2 illustrates an example verifier mesh (e.g., distributed mesh, distributed ACS mesh) 200 that may implement the verifier 106 of FIG. 1. The verifier mesh 200 includes a first verifier (e.g., mesh node) 202A, a second verifier 202B, a third verifier 202C, and a fourth verifier 202 D. Each verifier 202A-D is a computing device such as a server, a personal computer, a workstation, a mobile device, or any other type of computing device. In some examples, one or more of the verifiers 202A-D is an application. In some examples, one or more of the verifiers 202A-D is an Application-Specific Integrated Circuit, an XPU, a Field-Programmable Gate Array, and other any other processor circuitry and/or combination of processor circuitries.

The verifiers 202A-D request and/or otherwise obtain attestation evidence from the attester 102, endorsements from the endorser 108, and reference values from the reference value provider 110. In some examples, the verifiers 202A-D identify a format of the attestation evidence, reference values, and endorsements and processes the attestation evidence, reference values, and endorsements based on the identified format. In some examples, the verifiers 202A-D identify the type of endorsement (e.g., a direct endorsement or a conditional endorsement) and processes the endorsements based on their types. A conditional endorsement is an endorsement which is only applied if the attester is in a certain operating state. A direct endorsement endorses the attester without depending on a specific attester state. The verifiers 202A-D extract appraisal context information from the attestation evidence, the reference values, and the endorsements. In some examples, appraisal context information includes properties (e.g., name (e.g., UUID, OID, URI), parameters (e.g., a range of possible contexts), type) of an appraisal context. The verifiers 202A-D create appraisal context metadata from the appraisal context information. The following CDDL describes examples of ACH metadata:

ACH meta-data = {
? appraisal-context-name => $name
? appraisal-context-parameters => $parameters
? appraisal-context-type => $type
}
$name /= UUID, $name /= OID, $name /= URI
$parameters /= [1* any]
$type /= certificate, $type /= token.

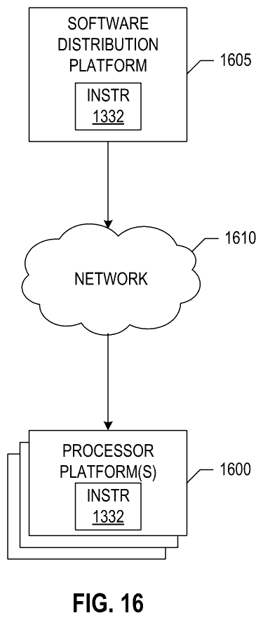

The verifiers 202A-D generate a network of nodes based on the extracted appraisal contexts. In some examples, each node in the network of nodes corresponds to an appraisal context. The appraisal context provides scoping context, allowing the verifiers 202A-D to appraise attestation evidence, reference values, and endorsements that correspond to the same appraisal context together. The verifiers 202A-D generate an accepted claims set (ACS). The ACS is a representation of the operating state of the attester 102 and includes the collection of attestation evidence offered by the attester 102 and accepted by the verifiers 202A-D. Example accepted claim sets are illustrated in FIGS. 17-42. The verifiers 202A-D evaluate attestation evidence offered by the attester based on endorsements and reference values. If the verifiers 202A-D accept the evidence, they add the evidence to the ACS.

In the illustrated example of FIG. 2, each of the verifiers 202A-D is communicatively coupled to at least one of the other verifiers 202A-D. In the example mesh 200, the verifiers 202A-D transfer information such as evidence and/or partial accepted claims sets via a conceptual message wrapper (CMW) format. In other examples, alternative communication approaches may be used.

The verifiers 202A-D cooperate to process attestation inputs to the verifier mesh 200 and, upon completion, generate a finalized ACS that has the same stateful representation of the attester 102 as if it were performed by a single verifier 106. Each verifier 202A-D contributes to the generation of a finalized ACS and the verifier mesh 200 architecture ensures a final ACS is generated by at least one verifier 202. The verifiers 202A-D in the verifier mesh 200 also have an additional input, which includes partial ACS results generated by peer mesh nodes 202 and/or other attestation information forwarded by a peer mesh node 202. As shown in the illustrated example of FIG. 2, each verifier 202A-D generates a corresponding ACS 204A-D. In the illustrated example of FIG. 2, verifiers 202A-C generate corresponding partial ACSs 204A-C and verifier 202D generates a finalized ACS 204D. Verifier 202B uses, as input to generate the partial ACS 202B, the partial ACS 204A generated by the verifier 202A. Likewise, the verifier 202C uses, as input to generate the partial ACS 204C, the partial ACSs 204A-B generated by the verifiers 202A-B. Finally, the verifier 202D generates the finalized ACS 204D using the partial ACSs 204B-C from the verifiers 202B-C.

In some examples, verifiers 202A-D utilize a synchronized clock and timing windows (e.g., quantum) for obtaining attestation information to ensure any one of the verifiers 202A-D does not receive additional and/or different attestation information than the other verifiers 202A-D, which can lead to inconsistent generation of attestation results. In some examples, verifiers 202A-D use a quantum, an epoch beacon, timer service, or bundling service (that quantizes verifier inputs) instead of or in addition to the synchronized clock. In some examples, the verifiers 202A-D utilize distributed ledger technology (DLT) to create a common but decentralized representation of the ACS 204. In some examples, the verifiers 202A-D perform periodic synchronization of ACSs 204A-D. For example, the verifiers 202A-D may use distributed 2-phase commit, saga pattern, etc. In some examples, the verifiers 204A-D and the final ACS 204D provide a content-defined network that enables generation of attestation results for a relying party based on an appraisal policy of the relying party. For example, a content-defined network may generate packets containing queries on the ACS that produces attestation results.

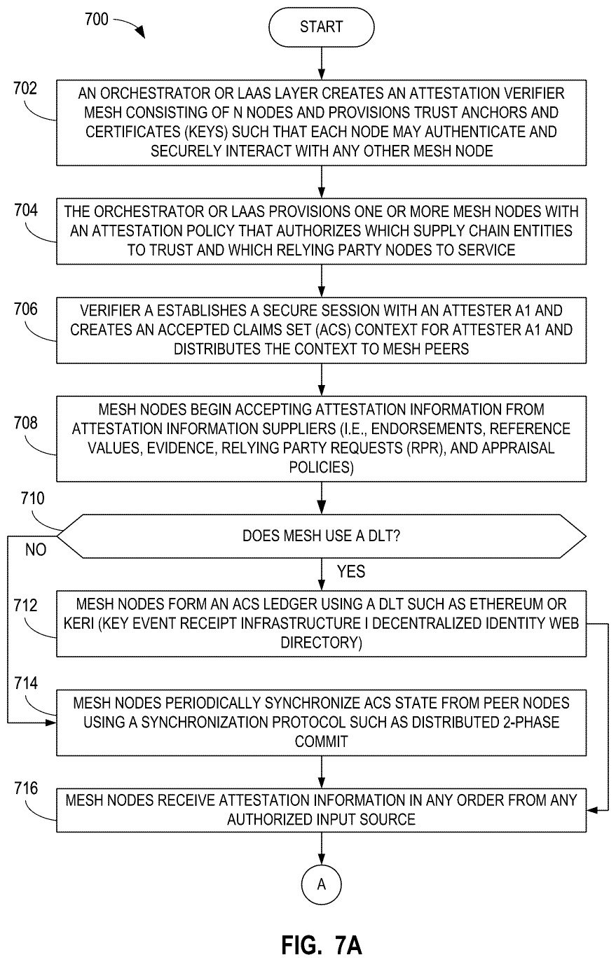

In some examples, to generate the ACS 204A-D, the verifiers 202A-D generate a first network of nodes corresponding to the bottom-up (e.g., a hierarchy that starts from a bottom of a tree or a lowest node) perspective based on evidence, reference values, and direct endorsements, and a second network of nodes corresponding to the top-down (e.g., a hierarchy that starts from a top of a tree or a highest node) perspective based on evidence, reference values, direct endorsements, and conditional endorsements. In some examples, the verifiers 202A-D combine the first network of nodes and the second network of nodes to create a combined network of nodes, the combined network of nodes aligning the bottom-up and the top-down representations of the attester state by matching common appraisal contexts. In some examples, the verifiers 202A-D are instantiated by programmable circuitry executing verifier instructions and/or configured to perform operations such as those represented by the flowcharts of FIGS. 7A-7B, 9, and 10. In some examples, the verifiers 202A-D process attestation evidence, reference values, and endorsements according to rules set by a verifier owner.

The verifier mesh 200 generates attestation results based on the combined network of nodes, attestation evidence, and appraisal policies and cause the attestation results to be sent to the relying party 104. In some examples, the entire ACS, a subset of the ACS, and/or a boolean yes/no attestation result for the attester 102 is generated by the verifier mesh 200.

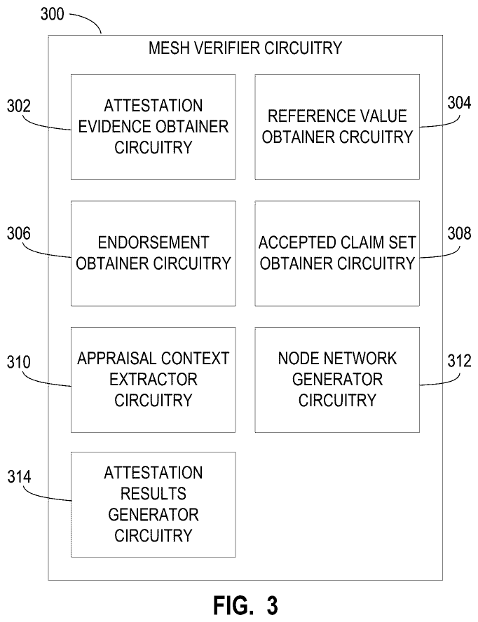

FIG. 3 is a block diagram of an example mesh verifier circuitry 300. Each of the example verifiers 202A-D of FIG. 2 may be implemented by the example mesh verifier circuitry 300 to generate attestation results. The mesh verifier circuitry 300 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the mesh verifier circuitry 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The example mesh verifier circuitry 300 of the illustrated example of FIG. 3 includes an example attestation evidence obtainer circuitry 302, an example reference value obtainer circuitry 304, an example endorsement obtainer circuitry 306, an example accepted claim set obtainer circuitry 308, an example appraisal context extractor circuitry 310, an example node network generator circuitry 312, and an example attestation results generator circuitry 314.

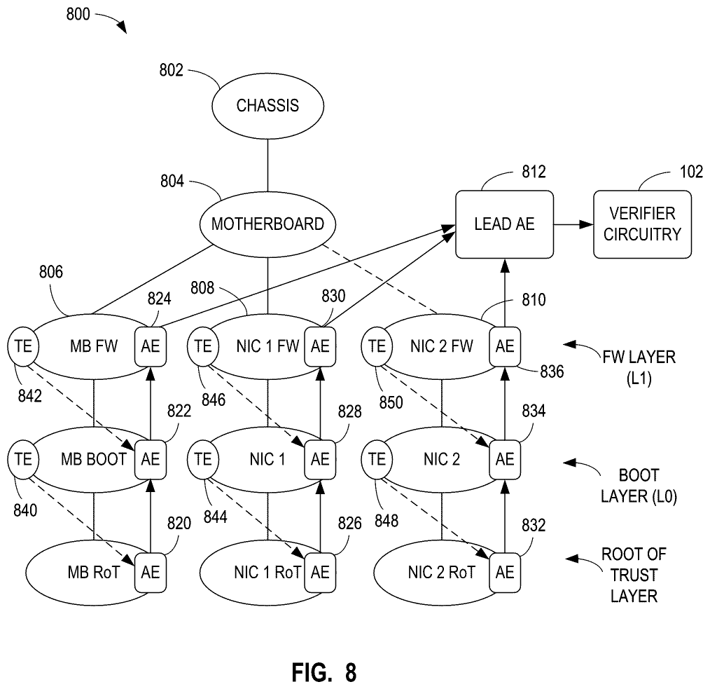

The example attestation evidence obtainer circuitry 302 of the illustrated example of FIG. 3 obtains attestation evidence from the attester 102. In some examples, the attestation evidence obtainer circuitry 302 requests attestation evidence from the attester 102. The attestation evidence obtainer circuitry 302 sends the attestation evidence to the appraisal context extractor circuitry 310. In some examples, the attestation evidence obtainer circuitry 302 sends the attestation evidence to the node network generator circuitry 312. In some examples, the attestation evidence obtainer circuitry 302 identifies a format of the attestation evidence and includes the identified format with the attestation evidence. In some examples, the evidence obtainer circuitry 302 is instantiated by programmable circuitry executing evidence obtainer instructions and/or configured to perform operations such as those represented by the flowchart of FIG. 9.

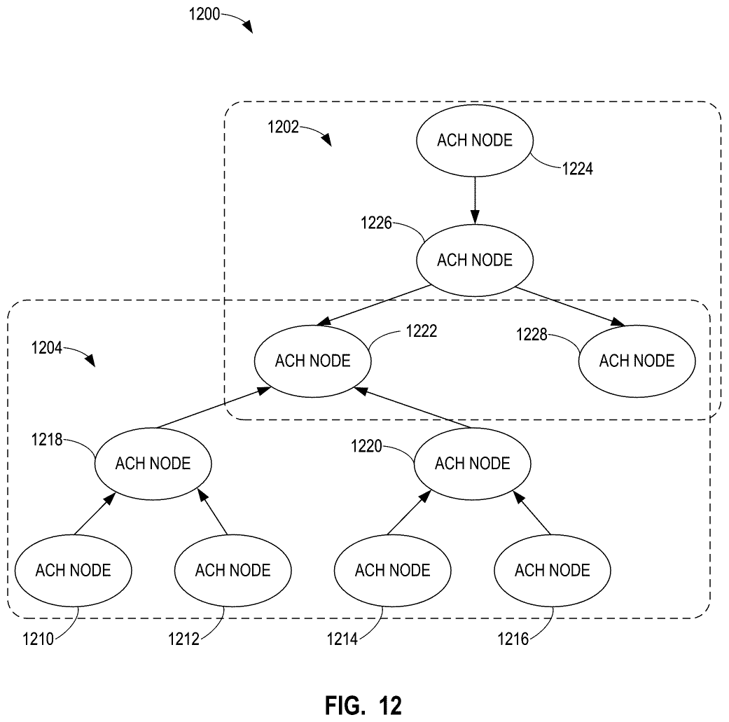

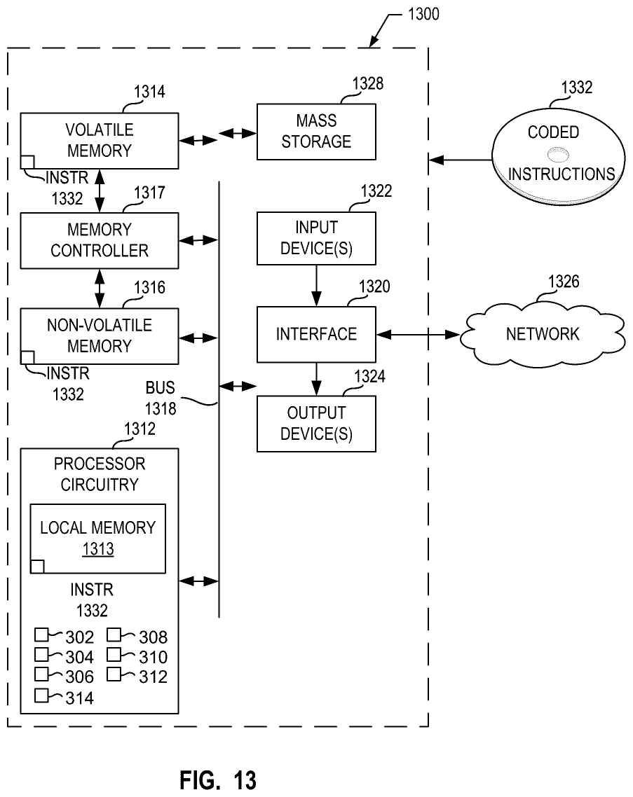

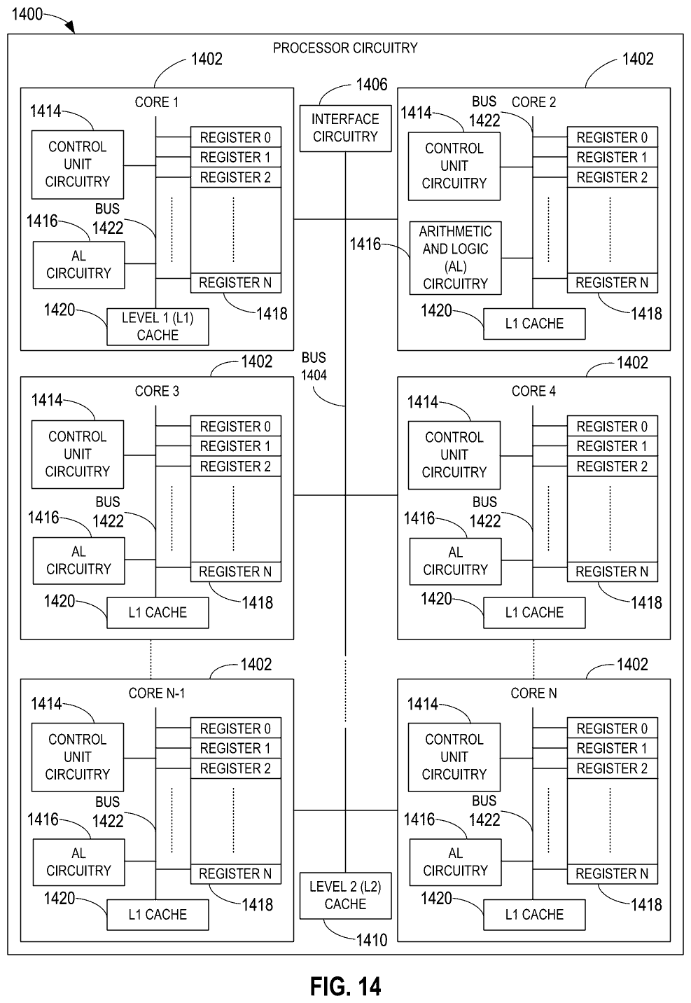

In some examples, the mesh verifier circuitry 300 includes means for obtaining attestation evidence from an attester 302. For example, the means for obtaining may be implemented by attestation evidence obtainer 302. In some examples, the attestation evidence obtainer 302 may be instantiated by programmable circuitry such as the example programmable circuitry 1312 of FIG. 13. For instance, the attestation evidence obtainer 302 may be instantiated by the example microprocessor 1400 of FIG. 14 executing machine executable instructions such as those implemented by at least block 906 of FIG. 9. In some examples, the attestation evidence obtainer 302 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the attestation evidence obtainer 302 may be instantiated by any other combination of hardware, software, and/or firmware. For example, the attestation evidence obtainer 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example reference value obtainer circuitry 304 of the illustrated example of FIG. 3 obtains reference values from a reference value provider. The reference value obtainer circuitry 304 sends the reference values to the appraisal context extractor circuitry 310. In some examples, the reference value obtainer circuitry 304 sends the reference values to the node network generator circuitry 312. In some examples, the reference value obtainer circuitry 304 identifies a format of the reference values and includes the identified format with the reference values. In some examples, the reference value obtainer circuitry 304 instantiated by programmable circuitry executing reference value obtainer instructions and/or configured to perform operations such as those represented by the flowchart of FIG. 9.

In some examples, the mesh verifier circuitry 300 includes means for obtaining reference values from a reference value provider. For example, the means for obtaining may be implemented by reference value obtainer circuitry 304. In some examples, the reference value obtainer circuitry 304 may be instantiated by programmable circuitry such as the example programmable circuitry 1312 of FIG. 13. For instance, the reference value obtainer circuitry 304 may be instantiated by the example microprocessor 1400 of FIG. 14 executing machine executable instructions such as those implemented by at least block 908 of FIG. 9. In some examples, the reference value obtainer circuitry 304 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the reference value obtainer circuitry 304 may be instantiated by any other combination of hardware, software, and/or firmware. For example, the reference value obtainer circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example endorsement obtainer circuitry 306 of the illustrated example of FIG. 3 obtains endorsements from an endorser. The endorsement obtainer circuitry 306 sends the endorsements to the appraisal context extractor circuitry 310. In some examples, the endorsement obtainer circuitry 306 sends the endorsements to the node network generator circuitry 310. In some examples, the endorsement obtainer circuitry 306 identifies a format of the endorsements and includes the identified format with the reference values. In some examples, the endorsement obtainer circuitry 306 identifies the type of endorsement (e.g., a direct endorsement or a conditional endorsement) and includes the identified type with the endorsement. In some examples, the endorsement obtainer circuitry 306 is instantiated by programmable circuitry executing endorsement obtainer instructions and/or configured to perform operations such as those represented by the flowchart of FIG. 9.

In some examples, the mesh verifier circuitry 300 includes means for obtaining endorsements from an endorser. For example, the means for obtaining may be implemented by endorsement obtainer circuitry 306. In some examples, the endorsement obtainer circuitry 306 may be instantiated by programmable circuitry such as the example programmable circuitry 1312 of FIG. 13. For instance, the endorsement obtainer circuitry 306 may be instantiated by the example microprocessor 1400 of FIG. 14 executing machine executable instructions such as those implemented by at least blocks 904, 916, and 936 of FIG. 9. In some examples, the endorsement obtainer circuitry 306 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the endorsement obtainer circuitry 306 may be instantiated by any other combination of hardware, software, and/or firmware. For example, the endorsement obtainer circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example accepted claim set obtainer circuitry 308 of the illustrated example of FIG. 3 obtains ACSs generated by other verifiers in the verifier mesh. The accepted claim set obtainer circuitry 308 sends the ACSs to the appraisal context extractor circuitry 310. In some examples, the accepted claim set obtainer circuitry 308 sends the ACSs to the node network generator circuitry 310. In some examples, the accepted claim set obtainer circuitry 308 is instantiated by programmable circuitry executing accepted claim set obtainer instructions and/or configured to perform operations such as those represented by the flowchart of FIGS. 7A and 7B.

In some examples, the mesh verifier circuitry 300 includes means for obtaining ACSs from a verifier. For example, the means for obtaining may be implemented by accepted claim set obtainer circuitry 308. In some examples, the accepted claim set obtainer circuitry 308 may be instantiated by programmable circuitry such as the example programmable circuitry 1312 of FIG. 13. For instance, the accepted claim set obtainer circuitry 308 may be instantiated by the example microprocessor 1400 of FIG. 14 executing machine executable instructions such as those implemented by at FIGS. 7A and 7B. In some examples, the accepted claim set obtainer circuitry 308 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the endorsement obtainer circuitry 306 may be instantiated by any other combination of hardware, software, and/or firmware. For example, the accepted claim set obtainer circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example appraisal context extractor circuitry 310 of the illustrated example of FIG. 3 extracts appraisal context information from attestation evidence, reference values, and endorsements. For example, a supplier may maintain an ontology, taxonomy, or database of components where a hierarchy of components may be represented such that a sub-component may be known to exist within its parent component. The supplier may assert endorsements including a component identifier (e.g., an OID) relevant to the endorsement. In that example, the appraisal context extractor circuitry 310 identifies the OID and records the OID for use in generation of appraisal context metadata. The appraisal context metadata is used in generation of a network of nodes. In some examples, the appraisal context extractor circuitry 310 sends the extracted metadata to the node network generator circuitry 312. In some examples, the appraisal context extractor circuitry 310 is instantiated by programmable circuitry executing appraisal context extractor instructions and/or configured to perform operations such as those represented by the flowchart of FIG. 9.

In some examples, the mesh verifier circuitry 300 includes means for extracting appraisal context metadata from attestation evidence, reference values, and endorsements. For example, the means for extracting may be implemented by appraisal context extractor circuitry 310. In some examples, the appraisal context extractor circuitry 310 may be instantiated by programmable circuitry such as the example programmable circuitry 1312 of FIG. 13. For instance, the appraisal context extractor circuitry 310 may be instantiated by the example microprocessor 1400 of FIG. 14 executing machine executable instructions such as those implemented by at least blocks 902, 906 of FIG. 9. In some examples, the appraisal context extractor circuitry 310 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the appraisal context extractor circuitry 310 may be instantiated by any other combination of hardware, software, and/or firmware. For example, the appraisal context extractor circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example node network generator circuitry 312 of the illustrated example of FIG. 3 generates a network of nodes based on appraisal contexts. In some examples, each node in the network of nodes corresponds to an appraisal context. The appraisal context provides scoping context, allowing the node network generator circuitry 312 to appraise evidence, reference values, and endorsements that correspond to the same appraisal context together. In some examples, the node network generator circuitry generates an ACS for the attester. The node network generator circuitry 312 evaluates evidence offered by the attester based on endorsements and reference values. If the node network generator circuitry 312 accepts the evidence, it adds the claims in the evidence to the ACS.

In some examples, the node network generator circuitry 312 generates a first network of nodes from the bottom-up perspective and a second network of nodes from the top-down perspective. In some examples, the node network generator circuitry 312 combines the first network of nodes and the second network of nodes to create a combined network of nodes, the combined network of nodes aligning the bottom-up and the top-down representations of the attester state by matching common appraisal contexts.

In some examples, the node network generator circuitry 312 begins by building the first network of nodes, corresponding to the bottom-up perspective. In some examples, the node network generator circuitry 312 locates a direct endorsement of an attester root-of-trust node. The node network generator circuitry 312 compares attestation evidence from the root-of-trust node, the attestation evidence about the parent node(s) of the root-of-trust node, to reference values corresponding to the parent node(s)—that is reference values with the same appraisal context as the attestation evidence. The node network generator circuitry 312 accepts claims about the parent node(s) if the comparison satisfies the node network generator circuitry 312. The node network generator circuitry 312 repeats this process for further parent nodes throughout the network of nodes, until a terminal node (e.g., a node with no parent nodes) is reached. In some examples, the node network generator circuitry 312 locates multiple root-of trust nodes and generates a different network of nodes for each root of trust. In some examples, the node network generator circuitry 312 combines the networks of nodes for the roots of trust when an appraisal context is common across the various nodes of the networks. In some examples, the node network generator circuitry 312 determines different networks of nodes for different roots of trust belong to the same device based on appraisal context metadata from both networks and creates a parent node to combine the two (or more) otherwise disparate networks of nodes.

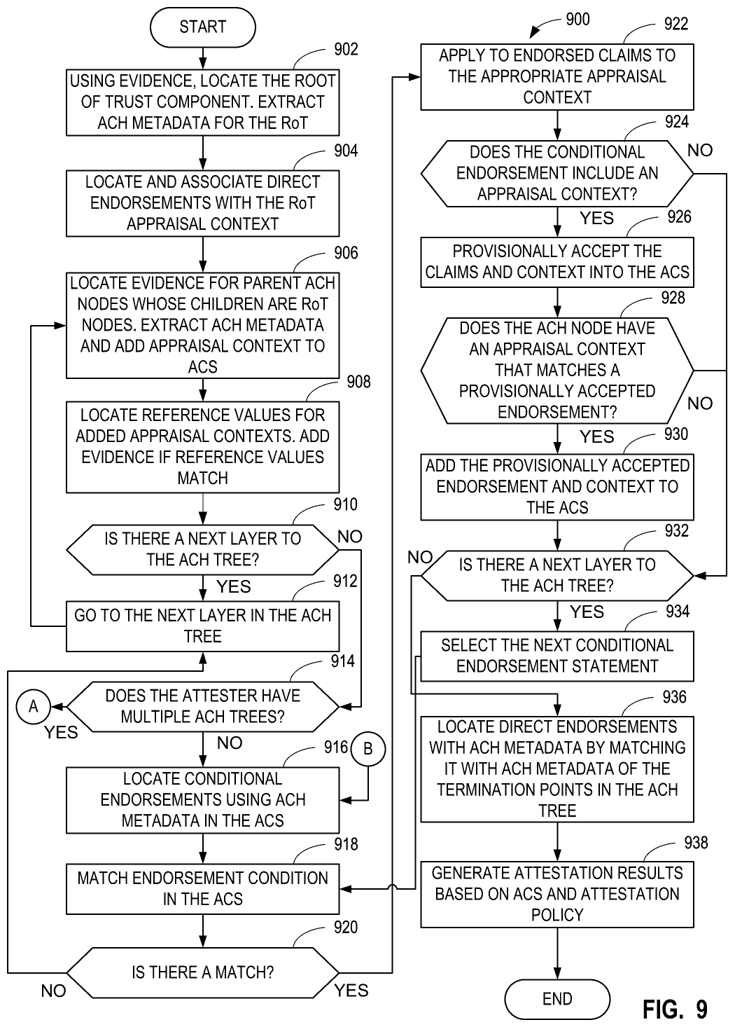

In some examples, the node network generator circuitry 312 generates the second network of nodes, corresponding to the top-down perspective. In some examples, the node network generator circuitry 312 locates a conditional endorsement using appraisal context metadata. In some examples, the node network generator circuitry 312 matches the condition for the conditional endorsement with accepted claims in the first network of nodes and accepts the endorsed claims for the appropriate node. In some examples, if the appraisal context for the endorsed claims does not match an appraisal context included in the network of nodes, the node network generator circuitry 312 provisionally accepts the claims into the ACS by creating a provisional node in the network. In some examples, the node network generator circuitry 312 processes conditional endorsements for the parent nodes of the network of nodes until a terminal node is reached. In some examples, if the appraisal context of a provisional node in the network matches the appraisal context of a parent node, the node network generator circuitry 312 adds the endorsement to the appraisal context and adds the endorsement to the ACS. In some examples, the node network generator circuitry 312 locates direct endorsements with appraisal context metadata matching the appraisal context of the terminal node(s) and adds the direct endorsements to the ACS. In some examples, the node network generator circuitry 312 is instantiated by programmable circuitry executing node network generator instructions and/or configured to perform operations such as those represented by the flowcharts of FIGS. 9 and 10.

In some examples, the mesh verifier circuitry 300 includes means for generating a network of nodes based on appraisal contexts. For example, the means for generating may be implemented by node network generator circuitry 312. In some examples, the node network generator circuitry 312 may be instantiated by programmable circuitry such as the example programmable circuitry 1312 of FIG. 13. For instance, the node network generator circuitry 312 may be instantiated by the example microprocessor 1400 of FIG. 14 executing machine executable instructions such as those implemented by at least blocks 902, 906, 910, 912, 914, 918, 920, 922, 924, 926, 928, 930, 932, 934, and 936 of FIG. 9 and blocks 1002, 1004, 1006, and 1008 of FIG. 10. In some examples, the node network generator circuitry 312 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the node network generator circuitry 312 may be instantiated by any other combination of hardware, software, and/or firmware. For example, the node network generator circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example attestation results generator circuitry 314 of the illustrated example of FIG. 3 generates attestation results based on a network of nodes and attestation evidence appraisal policies. In some examples, attestation results generator circuitry 314 causes the attestation results to be sent to the relying party 104. In some examples, the attestation results generator circuitry 314 sends the entire ACS to the relying party 104. In other examples, the attestation results generator circuitry 314 generates the attestation results from a subset of the ACS based on an appraisal policy of the relying party 104. For example, the relying party 104 may have an appraisal policy that states the relying party 104 is only interested in information about appraisal contexts corresponding to a particular network interface card on the attester device. In such a case, the attestation results generator circuitry 314 generates attestation results including only the accepted claims related to those appraisal contexts. In some examples, the attestation results generator circuitry 314 outputs a boolean yes/no attestation result for the attester based on the ACS and the appraisal policy. In some examples, the attestation results generator circuitry 314 is instantiated by programmable circuitry executing attestation results generator instructions and/or configured to perform operations such as those represented by the flowchart of FIG. 9.

In some examples, the mesh verifier circuitry 300 includes means for generating attestation results based on a network of nodes and attestation evidence appraisal policies. For example, the means for generating may be implemented by attestation results generator circuitry 314. In some examples, the attestation results generator circuitry 314 may be instantiated by programmable circuitry such as the example programmable circuitry 1312 of FIG. 13. For instance, the attestation results generator circuitry 314 may be instantiated by the example microprocessor 1400 of FIG. 14 executing machine executable instructions such as those implemented by at least block 938 of FIG. 9. In some examples, the attestation results generator circuitry 314 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the attestation results generator circuitry 314 may be instantiated by any other combination of hardware, software, and/or firmware. For example, the attestation results generator circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the mesh verifier circuitry 300 is illustrated in FIG. 3, one or more of the elements, processes, and/or devices illustrated in FIG. 3 may be combined, divided, re-arranged, omitted, eliminated, and/or implemented in any other way. Further, the example attestation evidence obtainer circuitry 302, the example reference value obtainer circuitry 304, the example endorsement obtainer circuitry 306, the example accepted claim set obtainer circuitry 308, the example appraisal context extractor circuitry 310, the example node network generator circuitry 312, the example attestation results generator circuitry 314, and/or, more generally, the example mesh verifier circuitry 300 of FIG. 3, may be implemented by hardware alone or by hardware in combination with software and/or firmware. Thus, for example, any of the example attestation evidence obtainer circuitry 302, the example reference value obtainer circuitry 304, the example endorsement obtainer circuitry 306, the example accepted claim set obtainer circuitry 308, the example appraisal context extractor circuitry 310, the example node network generator circuitry 312, the example attestation results generator circuitry 314, and/or, more generally, the example mesh verifier circuitry 300, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example mesh verifier circuitry 300 of FIG. 3 may include one or more elements, processes, and/or devices in addition to, or instead of, those illustrated in FIG. 3, and/or may include more than one of any or all of the illustrated elements, processes and devices.

Flowcharts representative of example machine readable instructions, which may be executed by programmable circuitry to implement and/or instantiate the mesh verifier circuitry 300 of FIG. 3 and/or representative of example operations which may be performed by programmable circuitry to implement and/or instantiate the mesh verifier circuitry 300 of FIG. 3, are shown in FIGS. 7A, 7B, 9, and 10. The machine readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 7A, 7B, 9, and 10, many other methods of implementing the example mesh verifier circuitry 300 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable, and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7A, 7B, 9, and 10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

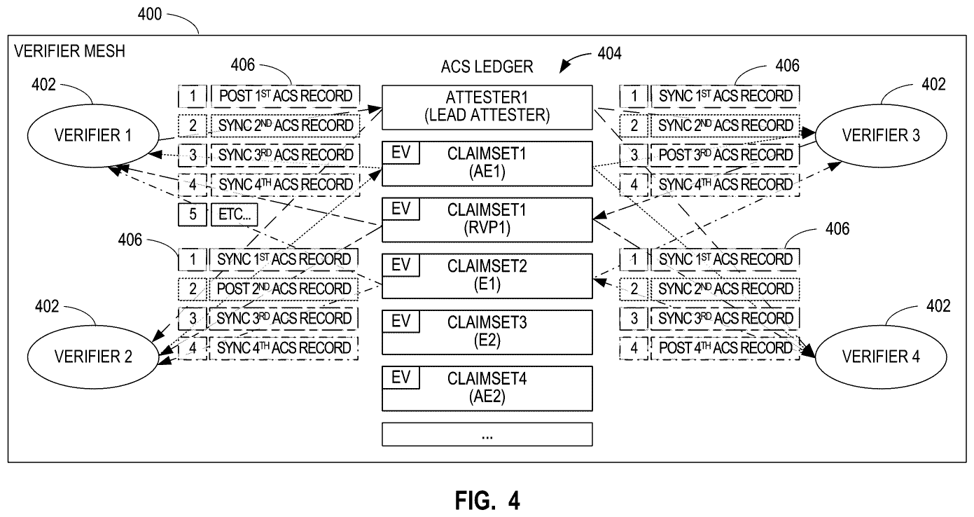

FIG. 4 illustrates an example verifier mesh 400 utilizing distributed ledger technology (DLT) to manage ACS state change. The verifier mesh 400 depicted in FIG. 4 includes four verifiers (e.g., mesh nodes) 402 that contribute records to an ACS ledger 404. Since the ACS 404 maintains ACS 404 integrity according to an append-only strategy, it can be adapted for use with DLT, as DLTs are also append-only. This example shows all four nodes contributing a record 406—identified by solid lines, where upon the DLT consensus algorithm synchronizes the ACS 404 state across the other three nodes—identified by dashed lines. A processing sequence of four records is shown. Consensus is reached when all verifiers in the DLT have candidate ACS sets with the same records. Different orderings of records in the ACS sets does not make the sets unequal. However, a particular ordering may be necessary for a digest of the ACS to be calculated to be contributed to a block of the DLT.

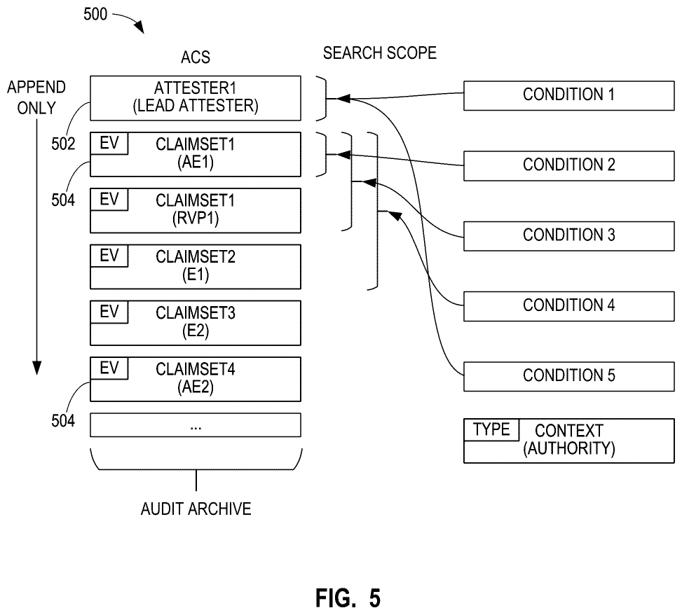

FIG. 5 is a block diagram illustrating condition processing implemented by the mesh verifier circuitry 300. The example in FIG. 5 shows a set of records being appended to an ACS 500 that was allocated for “Attester1”. The mesh verifier circuitry 300 may manage multiple simultaneous connections/sessions involving multiple attesters. Different attesters have distinct ACSs. ACS records may arrive in any order and from any entity once the initial ACS is created.

Once the mesh verifier circuitry 300 has translated attestation message inputs to an internal representation, the information is staged for processing. The primary objective is to bundle attestation information according to a self-consistent record that is stateful (that is to say the records in the ACS represent actual operational state of the Attester). Stateful records are appended to a log of stateful records known as the ACS 500. The first record 502 in the ACS 500 identifies the Attester (e.g., the “lead” attester) that is the communication endpoint between the Attester and the Verifier. An ACS record consists of several parts: a context—a tuple consisting of an ACS condition and a claimset that is to be appended to the ACS if the condition matches; and authority—the identity of the entity that asserted (provided) the record; and the type—the type of attestation information asserted (for example: Evidence (EV), Reference Values (RV), Endorsements (EN), etc. . . . ). The tuple may contain a profile identifier that indicates whether there are additional processing rules that are specific to a profile.

In the illustrated example of FIG. 5, two evidence records 504 are asserted at different times. The search scope arrows illustrate the relevant parts of the ACS 500 that the record's matching condition should satisfy. The search scope for evidence is the initial ACS record 502, meaning evidence can be appended at any time.

When processing reference values (RV), the condition specifies an evidence claimset. Typically, a manufacturer of a device that generates evidence will assert reference values that, if different from evidence, represents a trustworthiness relevant event has taken place—such as a compromised attester. Reference values may contain a multiplicity of valid values such that an evidence value may match a subset of the reference values. When an evidence value matches a reference value it is said to be “corroborated”, meaning the state of the attester described by evidence is also asserted by the reference value provider as being the state of the attester. The ACS may therefore contain a corroborated evidence record that has the reference value provider's authority. The search scope covers both the evidence and reference records and the claimset for each record should be the same.

When processing endorsement (EN) values, the condition specifies a claimset that falls within the current ACS 500 (e.g., records 0-3 in FIG. 5 for Condition4 from record 4.

If a condition doesn't match, it could be because an expected record (or records) hasn't yet been appended to the ACS 500. The mesh verifier circuitry 300 may set this record aside to see if the expected records appear at some time in the future. Alternatively, the mesh verifier circuitry 300 may return the record to the sender, who may try again later.

When the mesh verifier circuitry 300 has completed processing of new records, the ACS state may be archived for auditing, compliance or other quality assurance purposes.

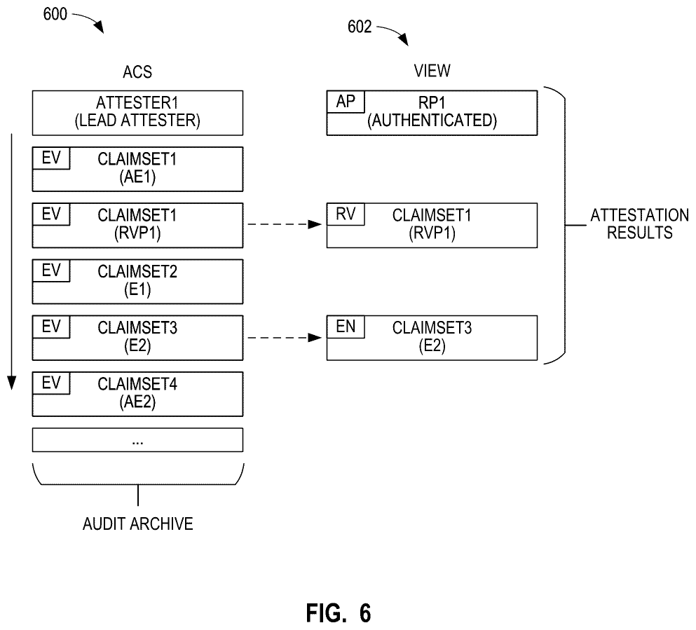

FIG. 6 is a block diagram illustrating ACS view processing based on a centralized ACS 600 implemented by the mesh verifier circuitry 300. The ACS 600 may grow over time as activity in the ecosystem produces new inputs to the ACS 600. Relying parties may interact with the ACS 600 dynamically, to assess attester trustworthiness state. The relying party may be interested in a subset of the ACS 600 for making trust-based decisions. Since the ACS 600 is append-only, appraisal policies from the relying party can't modify the ACS 600. Instead, the appraisal policy describes a view 602 of the ACS 600 that contains the claimsets interesting to the relying party. In this example, Claimset1 and Claimset3 are included in the RP1 view 602. In this manner, the verifier mesh 200 provides an attestation-based content-defined network, enabling relying parties to access portions of an attester trustworthiness state according to the relying parties' appraisal policies.

FIGS. 7A-7B are flowcharts representative of example machine readable instructions and/or example operations 700 that may be executed, instantiated, and/or performed by programmable circuitry to generate attestation results for a relying party. The example operations 700 may be executed by a mesh of nodes that use a DLT or other form of distributed synchronization method that ensures all mesh nodes have a consistent copy of the ACS. Any node in the mesh may receive and process any input (in the form of an attestation conceptual message) and append it to the distributed ACS. Processing terminates when all mesh nodes report that there aren't additional inputs to process. Relying parties may request a view restriction at any time, but the view is not final until the termination is finalized. Any mesh node may generate an access token for a Relying Party to access a View. The ACS may be archived for audit and compliance investigation.

The example machine-readable instructions and/or the example operations 700 of FIGS. 7A-7B begin at block 702, at which point an orchestrator or LAAS layer creates an attestation verifier mesh 200 consisting of n nodes and provisions trust anchors and certificates (keys) such that each node may authenticate and securely interact with any other mesh node. At block 704, the orchestrator or LAAS provisions one or more mesh nodes with an attestation policy that authorizes which supply chain entities to trust and which relying party nodes to service. At block 706, the verifier a establishes a secure session with an attester a1 and creates an ACS context for attester a1 and distributes the context to mesh peers. At block 708, mesh nodes begin accepting attestation information from attestation information suppliers (i.e., endorsements, reference values, evidence, relying party requests (RPR), and appraisal policies)

At block 710, a determination is made on whether the mesh uses a DLT? If the mesh uses a DLT (e.g., block 710 returns a result of YES), the example process 700 continues at block 712, where the mesh nodes form an ACS ledger using a DLT such as ethereum or keri (key event receipt infrastructure i decentralized identity web directory), and then to block 716. If the mesh does not use a DLT (e.g., block 710 returns a result of NO), example process 700 continues to block 714, at which point the mesh nodes periodically synchronize ACS state from peer nodes using a consensus protocol or a synchronization protocol such as distributed 2-phase (or 3-phase) commit. At block 716, the mesh nodes receive attestation information in any order from any authorized input source.

At block 718, attestation information is processed into an ACS record format that consists of at least a record type, condition, claimset, and authority artifacts. At block 720, mesh nodes process the condition by searching the ACS to find a matching claimset or state. for example, an evidence condition identifies the ACS for attester that asserted the evidence. an endorsement condition contains a claimset that already exists in the ACS. At block 722, the verifier mesh 200 determines whether the condition matches. If the condition does not match (e.g., block 722 returns a result of NO), the process continues to block 724, at which point the verifier mesh 200 sets the record aside for a later date and the process 700 continues to block 726. If the condition does match (e.g., block 722 returns a result of YES), the process 700 continues to block 726, at which point the verifier mesh 200 appends the record to the ACS.

At block 728, the verifier mesh 200 determines whether there are additional records to process. If there are (e.g., block 728 returns a result of YES), the example process 700 returns to block 718. If there are not additional records to process (e.g., block 728 returns a result of NO), whether any conditions include a validation function is determined at block 730. If any of the conditions do include a validation function (e.g., block 730 returns a result of YES), the validation function is applied to the matching claimset(s) in the ACS at block 732. For example, a claimset may contain a cryptographic key and a validation function may do CRL checks over the key. At block 734, whether an appraisal policy or a PRP contains a view restriction is determined. If there is a view restriction (e.g., block 734 returns a result of YES), the view restriction is processed by selecting a subset of the ACS that is placed in a view context at block 736. At block 738, the relying party is given access to the view context.

There are three classes of processing by which an ACS can be updated: 1) Basic Augmentation; 2) Validation Function; 3) View Restriction.

Basic Augmentation begins with an ACS that is an empty set. Attester binding—Attester instances have distinct ACS instances. The verifier authenticates Attester to instantiate the binding. The ACS changes state by processing augmentation tuples: Augmentation tuple: (<condition>, <update>,<authority>)=><output-set>; <update>—the Claimset to be added to the ACS; constrained by schema expressiveness; <output-set>—the Claimset added to the ACS with authority and tuple context (i.e., conceptual message type); If <condition> is true, then copy <update> with entity's <authority> to <output-set> and append it to ACS.

Triggers include: Evidence, References Value, and Endorsement Triples. Each type of input follows the stereotypical tuple structure: Evidence: (<empty-set>, <any claimset in the evidence domain>, <Attester binding context>)=><evidence-set>; Reference Values: (<evidence-set>, <any claimset in the reference values domain>, <any RVP trust anchor>)=><rvp-set>; Endorsement: (<evidence-set or rvp-set or previous endorsement-set>, <any claimset in the endorsement domain>, <any Endorser trust anchor>)=><endorsement-set>;

Examples: Evidence: (<>, <class-id=.3.2.1:digest=h′FED4′>, <key-id=h′01′>)=>; <[class-id=.3.2.1:digest-h′FED4′], key-id=h′01′>; RV: (<class-id=.3.2.1:digest=h′FED4′>, <>, <key-id=h′02′>)=>; <[class-id=.3.2.1:digest=h′FED4′], key-id=h′02′>; Endorsement #1: (<class-id=.3.2.1:digest=h′FED4′>, <class-id=.3.2.1:svn=7>, <key-id=h′03′>)=>; <class-id=.3.2.1:svn=7>, key-id=h′03′>; Endorsement #2: (<class-id=.3.2.1:svn=7, key-id=h′03′>, <class-id=.3.2.2:version=“1.0”>, <key-id=h′04′>)=>; <class-id=.3.2.2:version=“1.0”, key-id=h′04′>

ACS Contents: [[class-id=.3.2.1:digest=h′FED4′], key-id=h′01′, evs], [[class-id=.3.2.1:digest=h′FED4′], key-id=h′02′, rvs], [[class-id=.3.2.1:svn=7], key-id=h′03′, ens], [[class-id=.3.2.2:version=“1.0”], key-id=h′04′, ens]. If multiple Verifiers cooperate to produce ACS. Verifier1 partitions ACS into ACS1, ACS2, Verifier 2 augments ACS2, Verifier 3 consumes ACS1 and ACS2 to produce a final ACS3.

ACS1: [[class-id=.3.2.1:digest=h′FED4′], key-id=h′01′, evs], [[class-id=.3.2.1:svn=7], key-id=h′03′, ens], [[class-id=.3.2.3:digest=h′EDC3′], key-id=h′07′, evs]. ACS2: [[class-id=.3.2.1:digest-h′FED4′], key-id=h′01′, evs], [[class-id=.3.2.1: digest=h′FED4′], key-id=h′02′, rvs], [[class-id=.3.2.1:svn=7], key-id=h′03′, ens], [[class-id=.3.2.2:version=“1.0”], key-id=h′04′, ens]. ACS3-with duplicate removal: [[class-id=.3.2.1:digest=h′FED4′], key-id=h′01′, evs], [[class-id=.3.2.1:digest=h′FED4′], key-id=h′01′, evs], [[class-id=.3.2.1:digest=h′FED4′], key-id=h′02′, rvs], [[class-id=.3.2.1:svn=7], key-id=h′03′, ens], [[class-id=.3.2.1:svn=7], key-id=h′03′, ens], [[class-id=.3.2.3:digest=h′EDC3′], key-id=h′07′, evs], [[class-id=.3.2.2:version=“1.0”], key-id=h′04′, ens]

Validation Function Augmentation changes the ACS state. VF Augmentation tuple: (<condition>, <function>,<authority>)=><output-set>; <function>—An action applied to <condition> in ACS; <output-set>—The Claimset added to the ACS with authority and tuple context; If <condition> is true, then perform <function> with entity's <authority> and append <output-set> to ACS. Note: <output-set> could be <nil>; The trigger is VF triples: attest-key-triple-record, identity-key-triple-record.

Identity Key: (<class-id=.3.2.1, [key-id=h′01′]>, <key-id=h′05′>)=>; <VALID>.

ACS Contents: [[class-id=.3.2.1:digest=h′FED4′], key-id=h′01′, evs], [[class-id=.3.2.1:digest=h′FED4′], key-id=h′02′, rvs], [[class-id=.3.2.1:svn=7], key-id=h′03′, ens], [[class-id=.3.2.2:version=“1.0”], key-id=h′04′, ens], [[[class-id=.3.2.1:[key-id=h′01′], ikvf=VALID], key-id=h′05′, vfs].

ACS Restriction: View Restriction-An ACS subset is presented in a View: Restriction tuple: (<condition>, <authority>)=><output-set>; <condition>—A Claimset that is a subset of the ACS that selects Claimsets for placement in a View; <output-set>—The View; If <condition> is true, then select matching Claimsets from ACS and make them visible through <output-set> with requesting entity's <authority>.

Trigger: RP Request/Appraisal Policy. Example: Constrain by Trust Anchor: (<ta=[key-id=h′02′, key-id=h′04′]>, <key-id=h′06′>)=><View>. View Contents: [view-name=“MyView”, key-id=h′06′], [[class-id=.3.2.1:digest=h′FED4′], key-id=h′02′, rvs], [[class-id=.3.2.2:version=“1.0”], key-id=h′04′, ens].

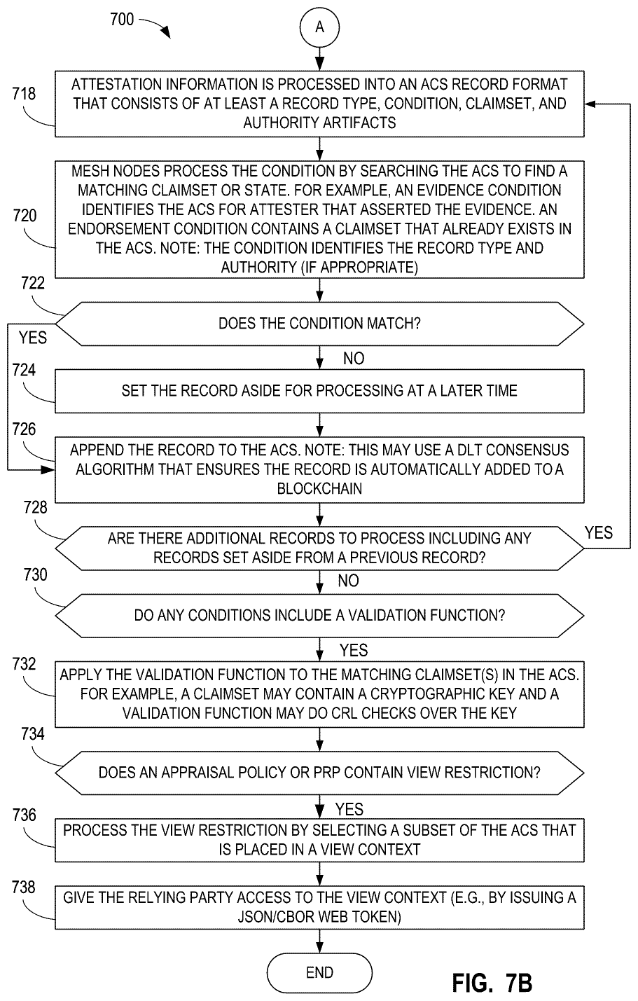

FIG. 8 is a conceptual diagram illustrating an example attester system 800. The example attester system 800 includes an example chassis 802, an example motherboard 804, an example motherboard (MB) firmware 806, an example statically bound network interface card (NIC) 808, a dynamically attached/hot-plug NIC 810, and example lead AE 812. Each of the MB firmware, and the individual NICs consist of three DICE-based layered components: a root of trust, a boot layer (e.g., layer 0), and a firmware layer (e.g., layer 1). In the illustrated example of FIG. 8, the example attester system 800 includes an example first attesting environment 820, an example second attesting environment 822, an example third attesting environment 824, an example fourth attesting environment 826, an example fifth attesting environment 828, an example sixth attesting environment 830, an example seventh attesting environment 832, an example eighth attesting environment 834, and an example ninth attesting environment 836. Attesting environments measure a target environment (TE)—that is, another component of the device. The example attester system includes an example first target environment 840, an example second target environment 842, an example third target environment 844, an example fourth target environment 846, an example fifth target environment 848, and an example sixth target environment 850. An attesting environment of the example attester system 800 measures a target environment, signs the measurement, and sends the signed measurement to a verifier. For example, the example first attesting environment 820 measures the example first target environment, signs the measurement, and sends the signed measurement to the verifier.

In some examples, a collection of target environments are grouped such that the resulting measurements are bundled and signed. For example, the example fifth attesting environment 828 is an embedded CA that issues a certificate containing evidence about the example fourth target environment 846. The signed bundle implicitly defines the appraisal context of the attestation evidence. The example attester system 800 includes an example first appraisal context 850, an example second appraisal context 852, an example third appraisal context 854, an example fourth appraisal context 856, an example fifth appraisal context 858, an example sixth appraisal context 860, an example seventh appraisal context 862, an example eighth appraisal context 864, and an example ninth appraisal context 866. In some examples, the implementation of the attester system assigns appraisal context names (ACN) (e.g., UUID, OID, URI) for some or all of the example appraisal contexts, defines appraisal context parameters (e.g., a range of m of n possible contexts), and or relies on the certificate as an implied context. In some examples, the components of an attester system may be instrumented with appraisal context metadata. Appraisal context metadata explicitly describes DICE layering semantics, trust dependency semantics, and/or semantic that can be inferred from the DICE certificate chain and various other data structures that are implementation dependent. In some examples, multiple appraisal contexts link to multiple parent appraisal contexts and a single appraisal context can link to multiple parent appraisal contexts. In the illustrated example of FIG. 8, appraisal context dependencies are represented as evidence flow lines from an attesting environment of one appraisal context to an attesting environment of another appraisal context. For example, the example second appraisal context 852 is a parent of the example first appraisal context 850, shown by the evidence flow line connecting the example first attesting environment 820 and the example second attesting environment 822.

FIG. 9 is a flowchart representative of example machine readable instructions and/or example operations 900 that may be executed, instantiated, and/or performed by programmable circuitry to generate attestation results for a relying party. The example machine-readable instructions and/or the example operations 900 of FIG. 9 begin at block 902, at which the appraisal context extractor circuitry 310 extracts ACH metadata for root of trust components of the attester 102. At block 904, the endorsement obtainer circuitry 306 locates and associates direct endorsements with the root of trust appraisal contexts. The node generator circuitry 312 adds the endorsements to a working set (e.g., an accepted claims set (ACS)) representing the state of the attester 102. At block 906, the attestation evidence obtainer circuitry 302 locates evidence for parent nodes of the current nodes, the appraisal context extractor circuitry 310 extracts ACH metadata from the attestation evidence, and the node network generator circuitry 310 adds the attestation evidence and appraisal contexts to an ACS. At block 908, the reference value obtainer circuitry 304 locates reference values for the added appraisal contexts and the node network generator circuitry 312 adds the evidence to the node network at the appropriate appraisal context if the evidence matches the reference values. At block 910 the node network generator circuitry 312 determines whether there is another layer in the network of nodes. If there is (e.g., block 910 returns a result of YES), the node network generator circuitry 312 goes to the next layer in the network (block 912) and returns to block 906. If there is not another layer of the network (e.g., block 910 returns a result of NO), the node network generator circuitry determines whether the attesting device 102 has multiple networks of nodes (block 914). If the attester 102 does have multiple networks of nodes (e.g., block 914 returns a result of YES), the process continues at block 1002 of FIG. 10. If the attester 102 does not have multiple networks of nodes (e.g., block 914 returns a result of NO), the endorsement obtainer circuitry 306 locates conditional endorsements using the ACH metadata included in the ACS (block 916). The endorsement obtainer circuitry 306 searches a repository of endorsements for matching appraisal context metadata.

At block 918, the node network generator circuitry 312 matches the endorsement conditions with the attestation information existing in the ACS. At block 920, the node network generator circuitry 312 determines whether there is a match. If there is not a match (e.g., block 920 returns a result of NO), the process returns to block 912. If there is a match (e.g., block 920 returns a result of YES), the node network generator circuitry 312 applies the endorsed claims to the appropriate appraisal context (block 922). At block 924, the appraisal context extractor circuitry 310 determines whether the conditional endorsement included an appraisal context. If the conditional endorsement does not include an appraisal context (e.g., block 924 returns a result of NO), the node network generator circuitry 312 applies the endorsement to the current node and the process proceeds to block 932. If the conditional endorsement does include an appraisal context (e.g., block 924 returns a result of YES), but the appraisal context does not exist in the network of nodes, the node network generator circuitry 312 provisionally accepts the claims and appraisal context into the ACS (block 926). The node network generator circuitry 312 creates a provisional node and assigs it the provisionally accepted appraisal context. If the appraisal context does exist in the network of nodes, the node network generator circuitry adds the endorsement to the corresponding node. At block 928, the node network generator circuitry 312 determines whether the network of nodes has an appraisal context that matches a provisionally accepted endorsement. If the network of nodes does have a matching appraisal context (e.g., block 928 returns a result of YES), the node network generator circuitry adds the provisionally accepted claims and appraisal context to the ACS (block 930). At block 932 the node network generator circuitry 312 determines whether there is another layer in the network of nodes. If there is another layer (e.g., block 932 returns a result of YES), then the node network generator circuitry 312 selects the next conditional endorsement (block 934) and returns to block 918. If there is not another layer (e.g., block 932 returns a result of NO), the endorsement obtainer circuitry 306 locates direct endorsements with ACH metadata matching the termination points in the network of nodes (block 936). At block 938, the attestation results generator circuitry 314 generates attestation results for the relying party 104 based on the ACS and attestation policy. Then, the example process 900 terminates.

FIG. 10 is a flowchart representative of example machine readable instructions and/or example operations 1000 that may be executed, instantiated, and/or performed by programmable circuitry to combine multiple networks of nodes of the same attester 102. The example machine-readable instructions and/or the example operations 1000 of FIG. 10 begin at block 1002, at which the node network generator circuitry 312 scans, for each of the networks of nodes, appraisal context metadata that identifies one of the other networks of nodes. At block 1004, the node network generator circuitry 312 determines whether two networks of nodes are part of the same attester 102. If two networks of nodes are determined to be part of the same attester 102 (e.g., block 1004 returns a result of YES), the node network generator circuitry 312 creates a new node that is a parent to both of the networks of nodes (block 1006). At block 1008, the node network generator circuitry 312 determines whether there is another network of nodes. If there is (e.g., block 1008 returns a result of YES), the node process returns to block 1002. If there is not (e.g., block 1008 returns a result of NO), the example process 1000 terminates, and example process 900 resumes at block 914.

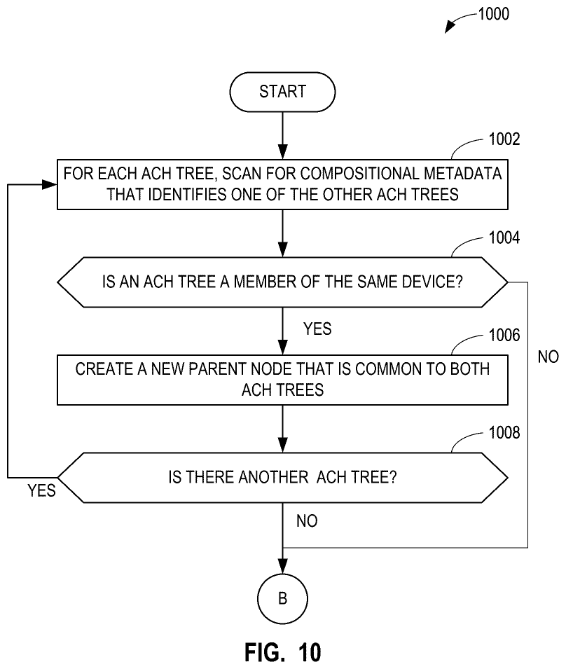

FIG. 11 is a conceptual diagram illustrating a combination of bottom-up and top-down description of another example attester system 1100. An example top-down description 1102 of the example attester system 1100 includes an example platform 1104 (e.g., a device platform) consisting of an example first component 1106 and an example second component 1108. The example first component consists of several sub-components including an example CPU 1110 consisting of an example first core 1112 and an example second core 1114, and an example controller 1116 consisting of an example first device 1118 and an example second device 1120. The example top-down description 1102 is observed from the perspective of a system designer (e.g., OEM, VAR). The top-down perspective is typical of a HW Bill of Materials. An example bottom-up description 1130 is observed from the perspective of multiple roots of trust. The example bottom-up description 1130 includes an example first root of trust 1132, an example second root of trust 1134, an example third root of trust 1136, and an example fourth root of trust 1138, an example first init code 1140, an example second init code 1142, an example first boot code 1144, an example second boot code 1146, an example system software 1148, and an example workload 1150. From each root of trust, there is init code that launches boot code, boot code that launches system SW, and system software that launches a workload. The bottom-up perspective is typical of a trusted or secure boot system.

An example attestation verifier 1160 aligns the example top-down description 1102 with the example bottom-up description 1130 to form a detailed representation of the attester system 1100. The attestation verifier 1160 accepts inputs from both the attester and various supply chain entities to produce a detailed picture of the attester state (which includes trustworthiness properties). The combined state is used to appraise the overall trustworthiness of the attester device. However, aligning the two perspectives correctly can be challenging. Reference value providers create manifests that describe reference values and endorsed values used for attestation from the top-down description 1102 of the attester. The attester produces attestation evidence to make claims about the operating state of the attester from the bottom-up description 1130 of the attester. In some examples, the attestation verifier 1160 aligns the two descriptions by matching reference values and endorsements to attestation evidence based on appraisal context metadata included with the reference values, endorsements, and attestation evidence. The appraisal context metadata can include an ACN, define appraisal context parameters, or rely on attestation evidence appraisal contexts. The attestation verifier 1160 aligns the descriptions by generating a first network of nodes for the bottom-up description 1130 and generating a second network of nodes for the top-down description 1102. In some examples, the attestation verifier 1160 compares the first network of nodes to the second network of nodes to identify common nodes based on appraisal context metadata. In some examples, the attestation verifier 1150 then combines the first network of nodes and the second network of nodes to generate a combined network of nodes which includes the attestation information from both the top-down description 1102 and the bottom-up description 1130.

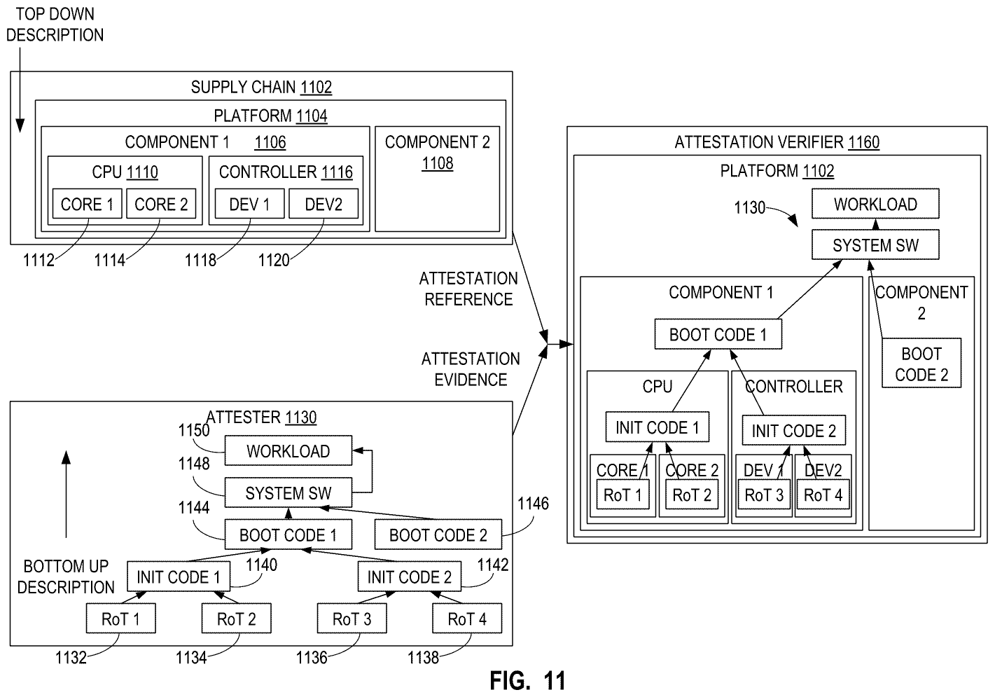

FIG. 12 is a conceptual diagram illustrating an example combined network of nodes 1200 generated by the mesh verifier circuitry 300 of FIG. 3. includes a first network of nodes 1202 corresponding to a bottom-up description of an attester and a second network of nodes 1204 corresponding to a top down-description of the attester. The first network of nodes includes a first root of trust node 1210, a second root of trust node 1212, a third root of trust node 1214, a fourth root of trust node 1216, a first intermediate node 1218, a second intermediate node 1220, and a terminal node 1222. Practical limitations prevent the full traversal of the first network of nodes 1202 from the root of trust nodes 1210-1216 to a root node 1224 of the attester. Furthermore, there are pragmatic conditions in which the top-down and bottom-up description logics are inconsistent. For example, a device ID certificate that describes an identity key, such as in an enclave, doesn't include the appraisal context. Similarly, the evidence format, such as an SPDM transcript, doesn't include the appraisal context. An attestation manifest, however, may include the appraisal context (as described by ACH Metadata).

The second network of nodes 1204 includes the root node 1224, an intermediary node 1226, the terminal node 1222, and a child node 1228. The mesh verifier circuitry 300 compares appraisal context metadata from the nodes of the first network of nodes 1202 and the nodes of the second network of nodes 1204 to identify that the terminal node 1222 is a common node of both networks 1202, 1204. For example, the attestation evidence in the bottom-up description of FIG. 12 might describe the first root of trust node 1210 in terms of a digest of software, while the top-down HW Bill of Materials might describe the first root of trust node 1210 in terms of a vendor name and device model string. A manifest may be created that relates the digest with the vendor and model information and includes appraisal context information. The mesh verifier circuitry 300 uses the appraisal context information to apply the namespace and scoping limitations that are appropriate. The mesh verifier circuitry 300 combines the first network of nodes 1202 and the second network of nodes 1204 at terminal node 1222 to generate the combined network of nodes 1206.

FIG. 13 is a block diagram of an example programmable circuitry platform 1300 structured to execute and/or instantiate the example machine-readable instructions and/or the example operations of FIGS. 7A, 7B, 9, and 10 to implement the mesh verifier circuitry 300 of FIG. 3. The programmable circuitry platform 1300 can be, for example, a server, a personal computer, a workstation, a self-learning machine (e.g., a neural network), a mobile device (e.g., a cell phone, a smart phone, a tablet such as an iPad™), an Internet appliance, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the attestation evidence obtainer circuitry 302, the reference value obtainer circuitry 304, the endorsement obtainer circuitry 306, the accepted claim set obtainer circuitry 308, the appraisal context extractor circuitry 310, the node network generator circuitry 312, and the attestation results generator circuitry 314.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 7A, 7B, 9, and 10, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 7A, 7B, 9, and 10 to effectively instantiate the circuitry of FIG. 3 as logic circuits to perform operations corresponding to those machine readable instructions. In some such examples, the circuitry of FIG. 3 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 7A, 7B, 9, and 10.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 7A, 7B, 9, and 10 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 7A, 7B, 9, and 10. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 7A, 7B, 9, and 10. As such, the FPGA circuitry 1500 may be configured and/or structured to effectively instantiate some or all of the operations/functions corresponding to the machine readable instructions of the flowcharts of FIGS. 7A, 7B, 9, and 10 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 7A, 7B, 9, and 10 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 7A, 7B, 9, and 10 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 15. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine readable instructions represented by the flowcharts of FIGS. 7A, 7B, 9, and 10 to perform first operation(s)/function(s), the FPGA circuitry 1500 of FIG. 15 may be configured and/or structured to perform second operation(s)/function(s) corresponding to a second portion of the machine readable instructions represented by the flowcharts of FIGS. 7A, 7B, 9, and 10, and/or an ASIC may be configured and/or structured to perform third operation(s)/function(s) corresponding to a third portion of the machine readable instructions represented by the flowcharts of FIGS. 7A, 7B, 9, and 10.

It should be understood that some or all of the circuitry of FIG. 3 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 3 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

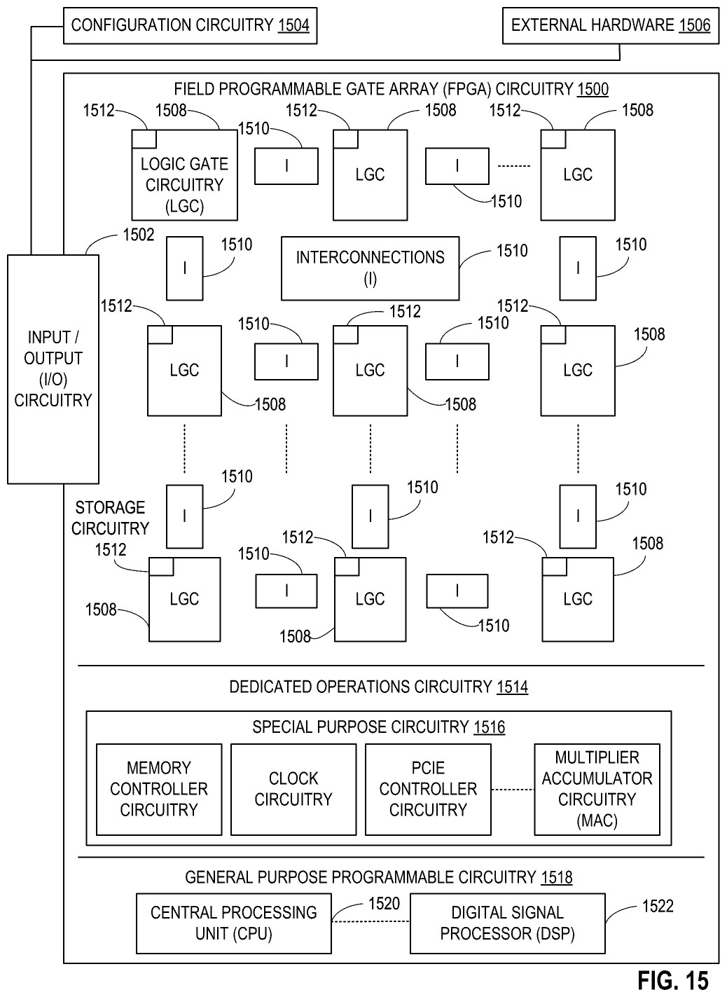

A block diagram illustrating an example software distribution platform 1605 to distribute software such as the example machine readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions of FIGS. 7A, 7B, 9, and 10, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions of FIGS. 7A, 7B, 9, and 10, may be downloaded to the example programmable circuitry platform 1300, which is to execute the machine readable instructions 1332 to implement the mesh verifier circuitry 300. In some examples, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices. Although referred to as software above, the distributed “software” could alternatively be firmware.

FIG. 17 illustrates example endorsements 1700 provided by an endorser for an attester for an example static composition, direct enforcement use case. The endorsements 1700 include an example chassis endorsements 1702, example motherboard endorsements 1704, and an example card endorsements 1706. The endorsements 1700 include example tags, example groups, example Environment Measurement Tuples (EMTs) (also called Environment Claims), example compositions (static or dynamic), and example trust dependencies. Tags (e.g., CoMIDs) are a grouping construct that contain either a reference (e.g., possible) state or actual (e.g., endorsed) state. Groups are an abstraction for appraisal contexts where claims within a group are evaluated together. EMTs are sets of claims, one claim describing an environment and another claim describing the state of the environment. Trust dependencies describe the AEs trusted with assessing a given TE. Composition is a grouping construct that enumerates the components of a system. Static composition enumerates the system at a time of manufacture, while dynamic composition enumerates the system at a time of attestation. An authority is the entity (or the entities) that asserted a given claimset and is typically a cryptographic key/key-id. An augmentation is a process of extending the ACS through condition matching. A validation function (VF) is a function that is applied to a claimset. A view is a claimset that is a subset of the ACS.

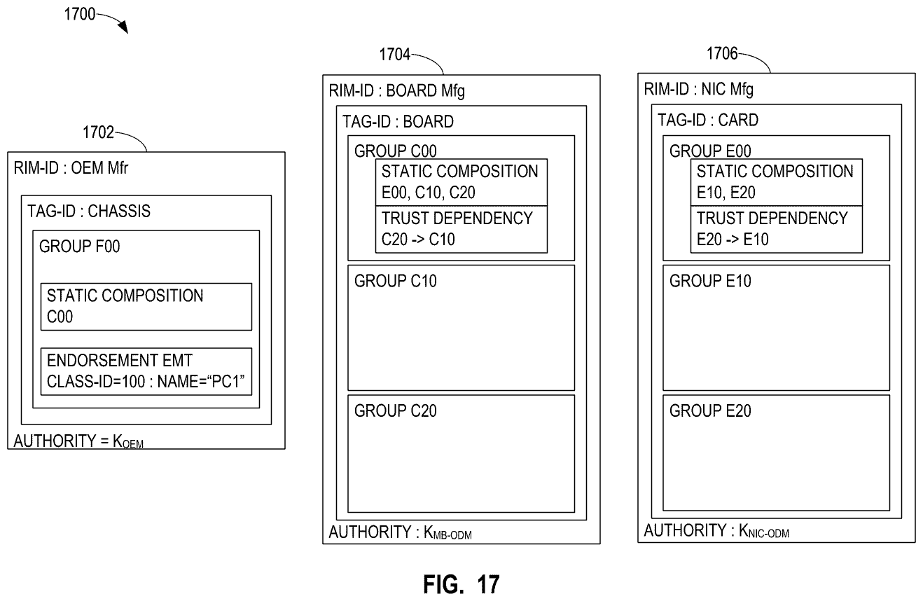

FIG. 18 illustrates an example ACS 1800 generated by the mesh verifier circuitry 300 of FIG. 3 for an attester for the example static composition, direct enforcement use case of FIG. 17. The ACS 1800 includes an example chassis appraisal context 1802, an example motherboard appraisal context 1804, and an example NIC appraisal context 1806. The example chassis appraisal context 1802, the example motherboard appraisal context 1804, and the example NIC appraisal context 1806 include the example chassis endorsements 1702, the example motherboard endorsements 1704, and the example card endorsements 1706, respectively.

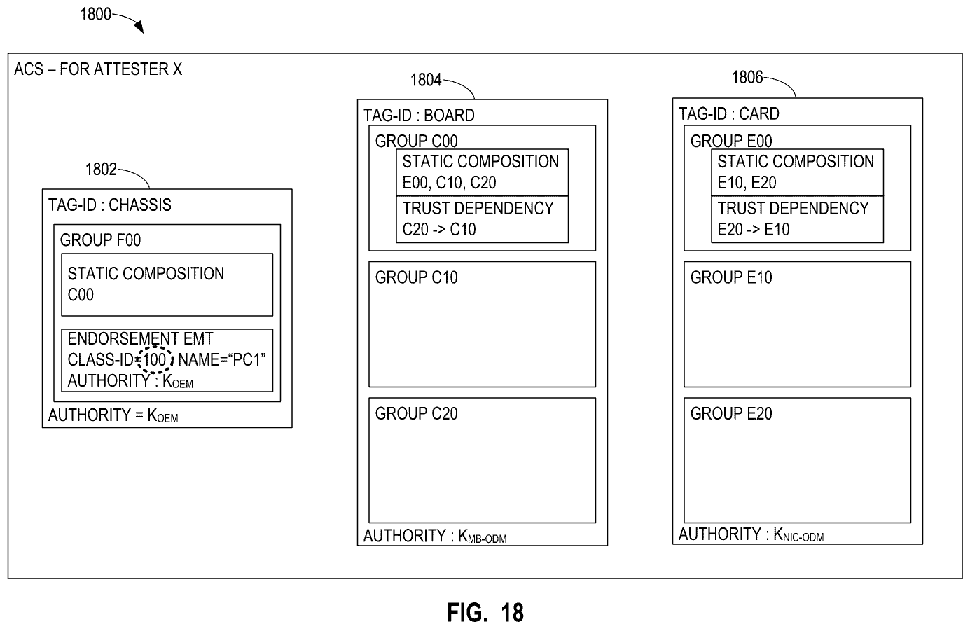

FIG. 19 illustrates example endorsements 1900 provided by an endorser for an attester and example attestation evidence 1902 from the attester for an example evidence matching use case. The endorsements 1900 include an example chassis endorsements 1904, example motherboard endorsements 1906, and an example card endorsements 1908. The example attestation evidence 1902 includes 4 four EMTs describing the state of the attester, each EMT including asserted claims and their associated authority.

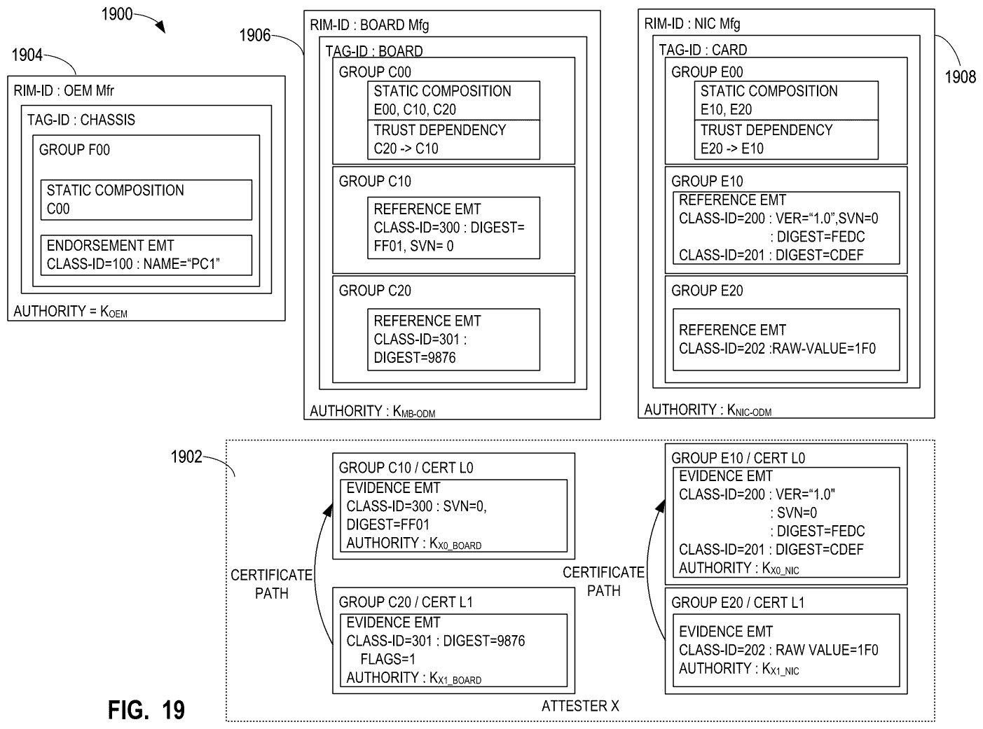

FIG. 20 illustrates an example ACS 2000 generated by the mesh verifier circuitry 300 of FIG. 3 for an attester for the example evidence matching use case of FIG. 19. The ACS 2000 includes an example chassis appraisal context 2002, an example motherboard appraisal context 2004, and an example NIC appraisal context 2006. The mesh verifier circuitry 300 accepts evidence claims under the attester authority. If reference values match accepted claims, then the reverence value provider authority is added to the matching claims.

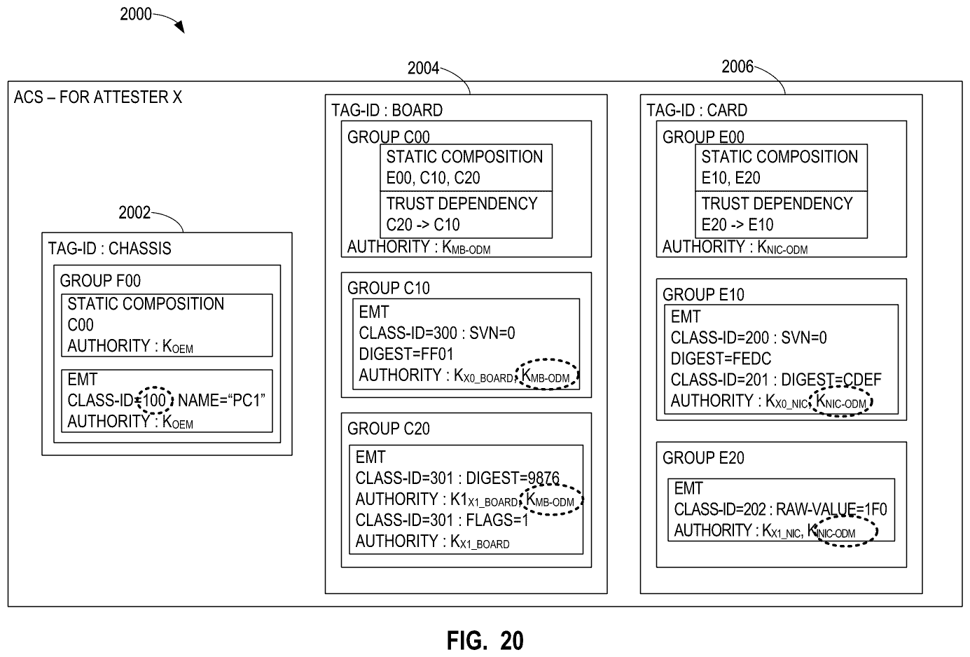

FIG. 21 illustrates an example NIC ACS 2100 generated by the mesh verifier circuitry 300 of FIG. 3 for a NIC of an attester for an example simple endorsement use case. The mesh verifier circuitry 300 matches the claims contained in the NIC ACS 2100 with an endorsement 2102 from a manufacturer of the NIC. The mesh verifier circuitry 300 accepts the endorsed claims in the endorsement 2102 into the NIC ACS 2100.

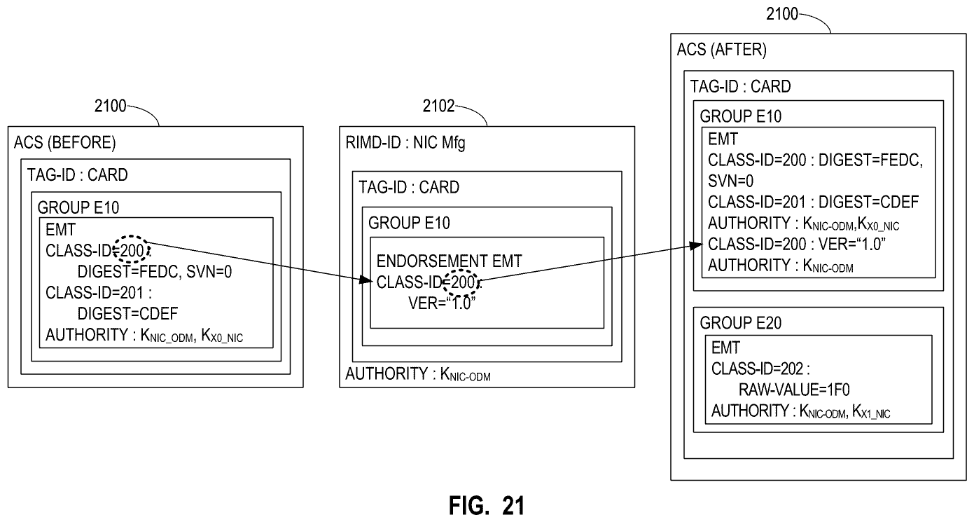

FIG. 22 illustrates an example ACS 2200 generated by the mesh verifier circuitry 300 of FIG. 3 for an attester for the example simple endorsement use case of FIG. 21. The example ACS 2200 is the example ACS 2000 updated with the claims in the endorsement 2102.

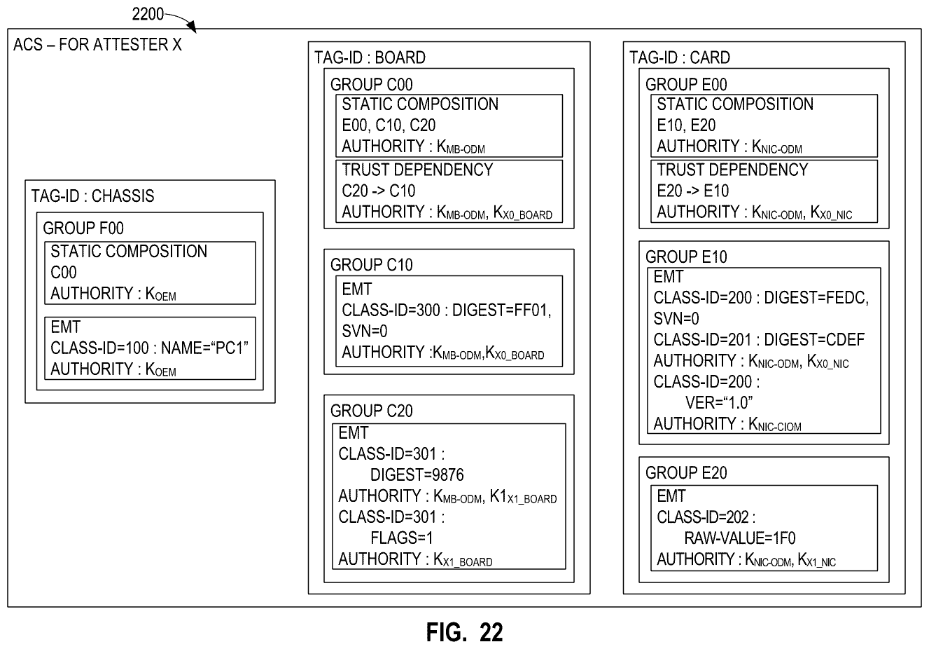

FIG. 23 illustrates example endorsements 2302 from an OEM manufacturer, example endorsements 2304 and reference values 2306 from a motherboard manufacturer, example attestation evidence 2308 from a first attester, and example attestation evidence 2310 from a second attester for an example update and patch use case. The example endorsements 2304 and reference values 2306 from the motherboard manufacturer include a description of a generation zero of the motherboard and a description of a generation one of the motherboard. The example attestation evidence 2308 is for an update zero. The example attestation evidence 2310 is for an update one.

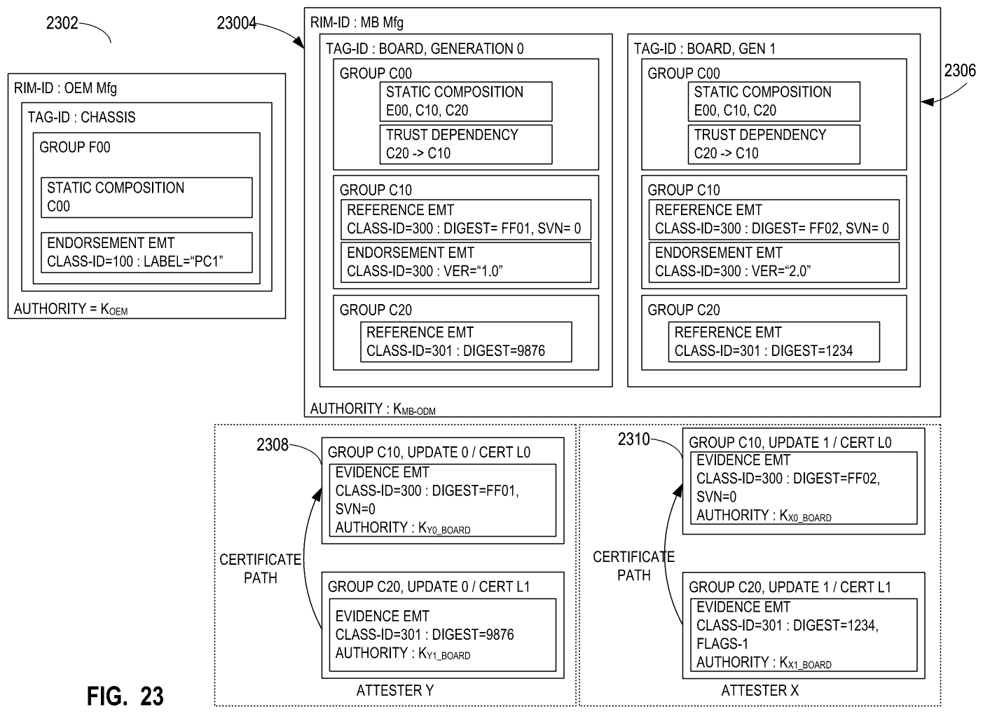

FIG. 24 illustrates an example ACS 2400 generated by the mesh verifier circuitry 300 of FIG. 3 for an attester for the example update and patch use case of FIG. 23. The ACS 2400 includes an example chassis appraisal context 2402, an example motherboard appraisal context 2404, and an example NIC appraisal context 2406. The mesh verifier circuitry 300 ignores the update zero appraisal context because the attestation evidence 2310 for update one matches the endorsement 2304 and reference values 2306 describing the generation one of the motherboard.

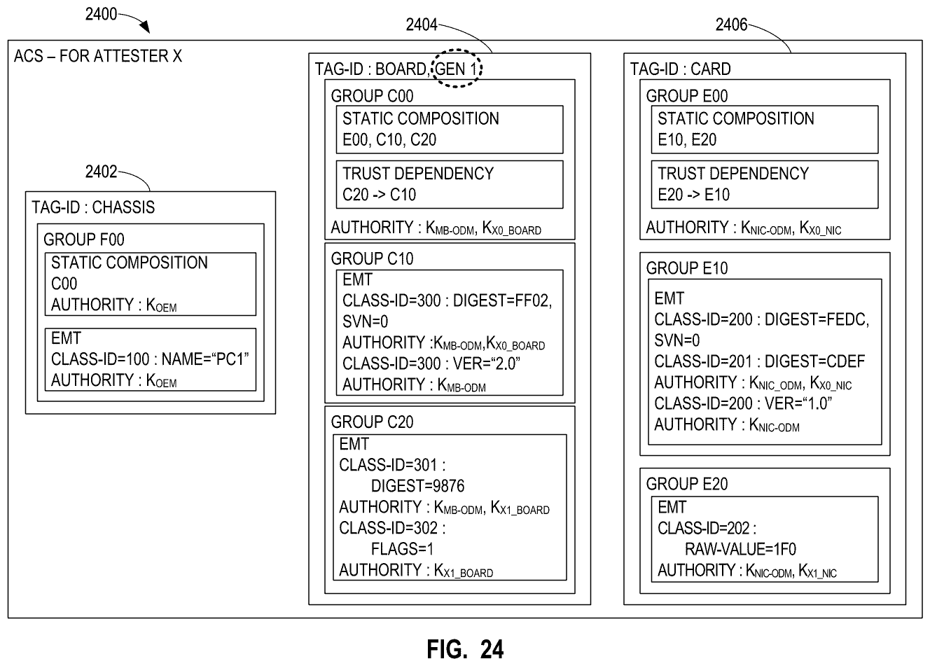

FIG. 25 illustrates example endorsements 2500 and reference values 2502 provided by a NIC manufacturer for a NIC of an attester and attestation evidence 2504 provided by the attester for an example dynamic composition use case.

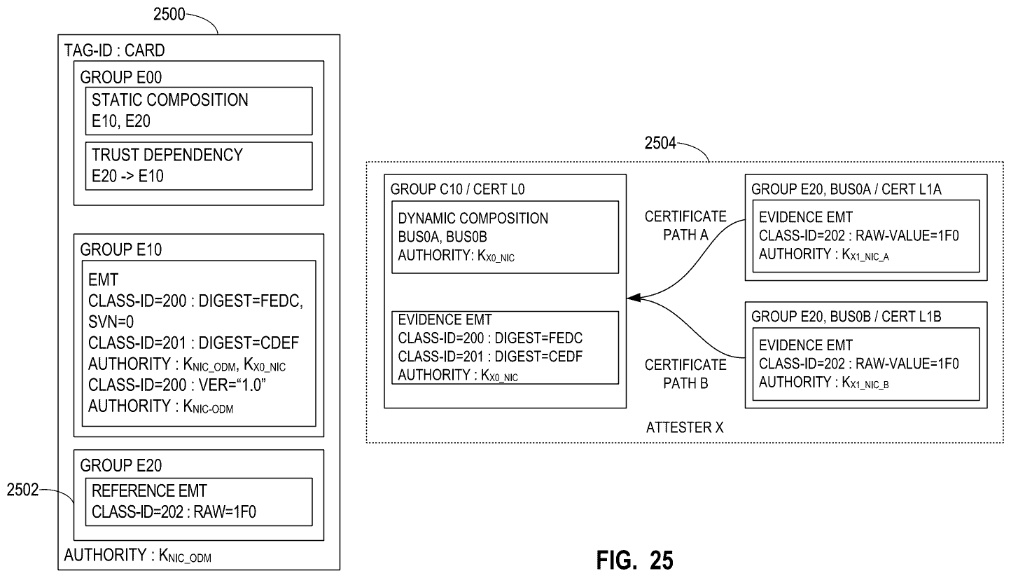

FIG. 26 illustrates an example ACS 2600 generated by the mesh verifier circuitry 300 of FIG. 3 for an attester for the example dynamic composition use case of FIG. 25. The ACS 2600 includes an example chassis appraisal context 2602, an example motherboard appraisal context 2604, and an example NIC appraisal context 2606. The AE discovered multiple TE instances not found in the static composition. The AE generated evidence for each instance and added a dynamic composition state.

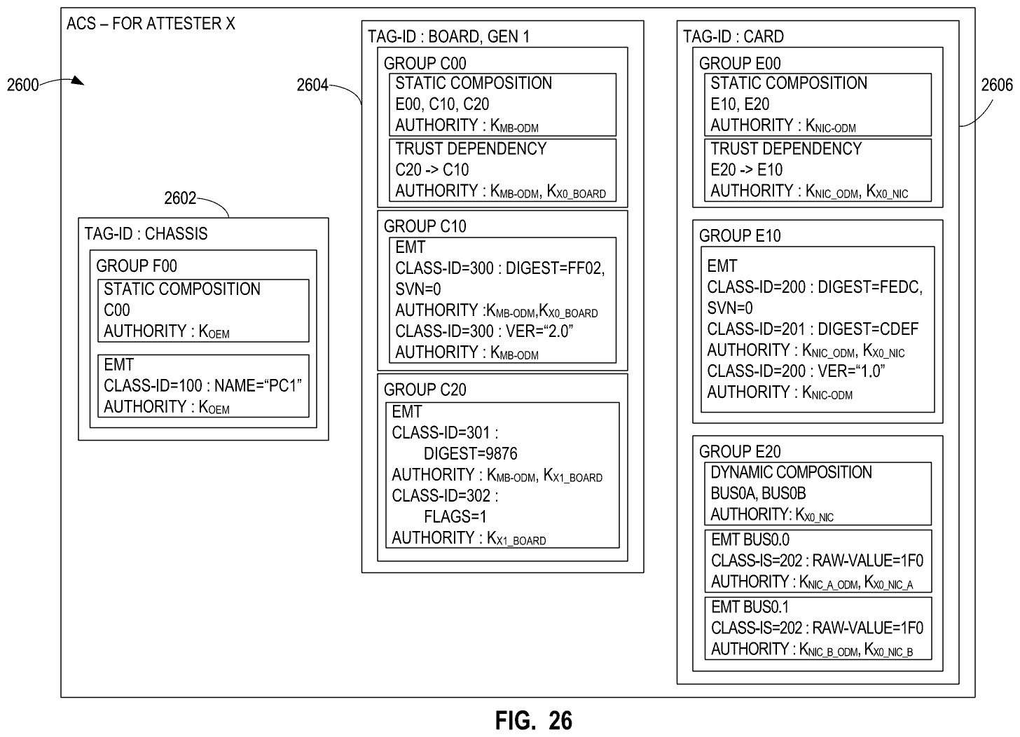

FIG. 27 illustrates an example NIC ACS 2700 generated by the mesh verifier circuitry 300 of FIG. 3 for a NIC of an attester for an example conditional endorsement use case. The mesh verifier circuitry 300 matches the claims contained in the NIC ACS 2700 with a conditional endorsement 2702 from a manufacturer of the NIC. The mesh verifier circuitry 300 accepts the claims in the conditional endorsement 2702 into the NIC ACS 2700 because the NIC ACS 2700 matches the expected state in the conditional endorsement 2702.

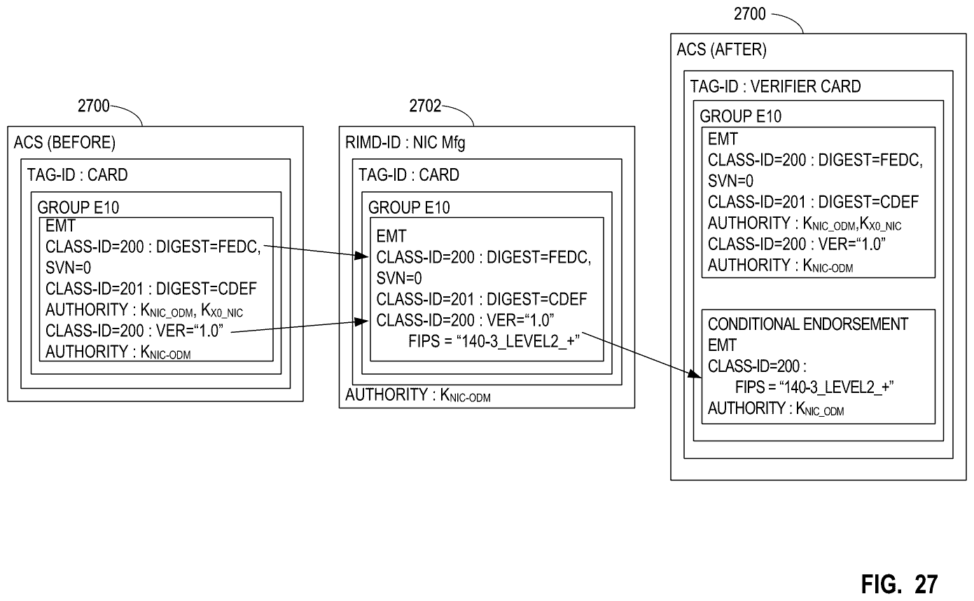

FIG. 28 illustrates an example ACS 2800 generated by the mesh verifier circuitry 300 of FIG. 3 for an attester for the example conditional endorsement use case of FIG. 27. The example ACS 2800 is the example ACS 2600 updated with the claims in the conditional endorsement 2702.

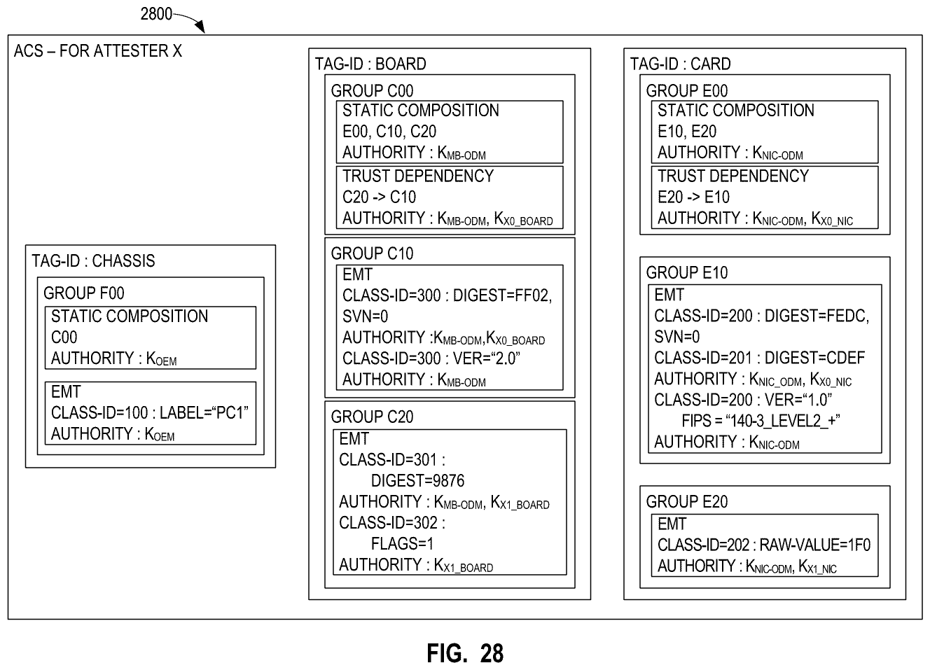

FIG. 29 illustrates an example NIC ACS 2900 generated by the mesh verifier circuitry 300 of FIG. 3 for a NIC of an attester for an example conditional endorsement series use case. The mesh verifier circuitry 300 matches the claims contained in the NIC ACS 2900 with a conditional endorsement series 2902 from a manufacturer of the NIC. The mesh verifier circuitry 300 first confirms the NIC ACS 2900 matches the expected state in the conditional endorsement series 2902. The mesh verifier circuitry 300 accepts the claims in the conditional endorsement series 2902 into the NIC ACS 2900 because a condition in the conditional endorsement series is true.

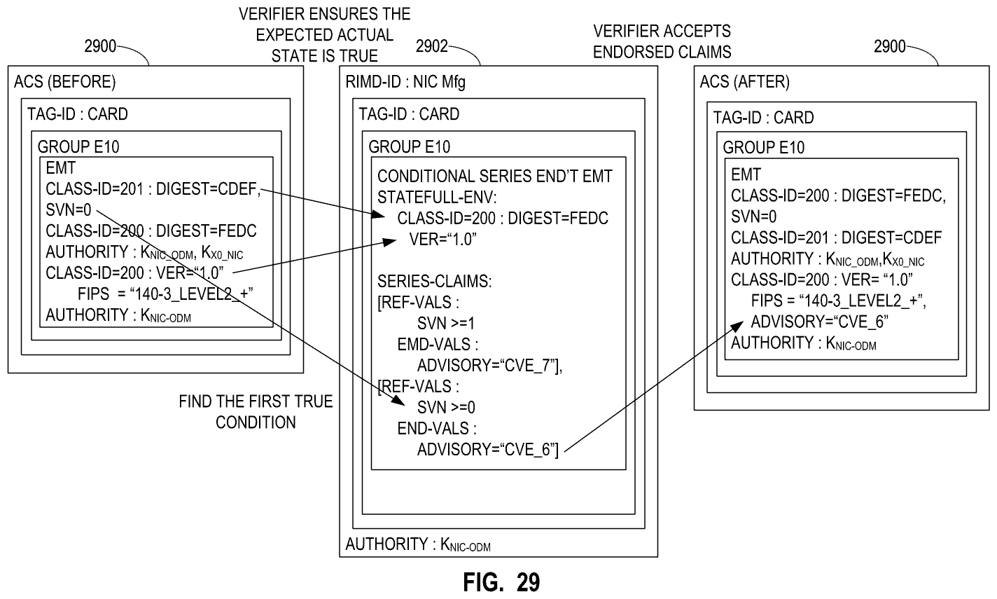

FIG. 30 illustrates an example ACS 3000 generated by the mesh verifier circuitry 300 of FIG. 3 for an attester for the example conditional endorsement series use case of FIG. 29. The example ACS 3000 is the example ACS 2800 updated with the claims in the conditional endorsement series 2902.

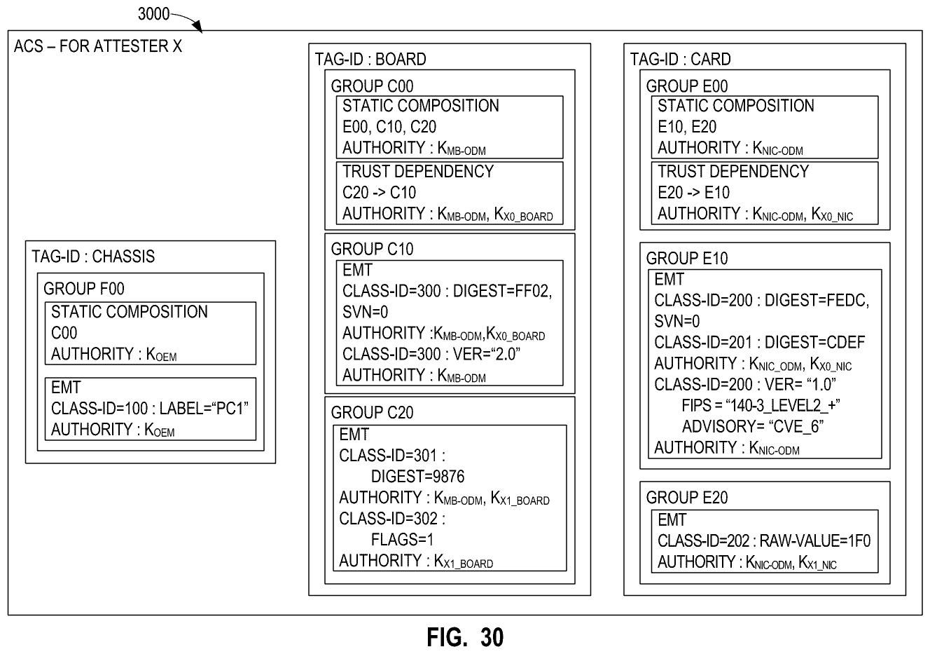

FIG. 31 illustrates an example NIC ACS 3100 generated by the mesh verifier circuitry 300 of FIG. 3 for a NIC of an attester for an example multi-endorsement use case. The mesh verifier circuitry 300 matches multiple environments contained in the NIC ACS 3100 with a multi-endorsement EMT 3102 from a manufacturer of the NIC. The mesh verifier circuitry 300 accepts the claims in the multi-endorsement EMT 3102 into the NIC ACS 3100 because all of the environments match.

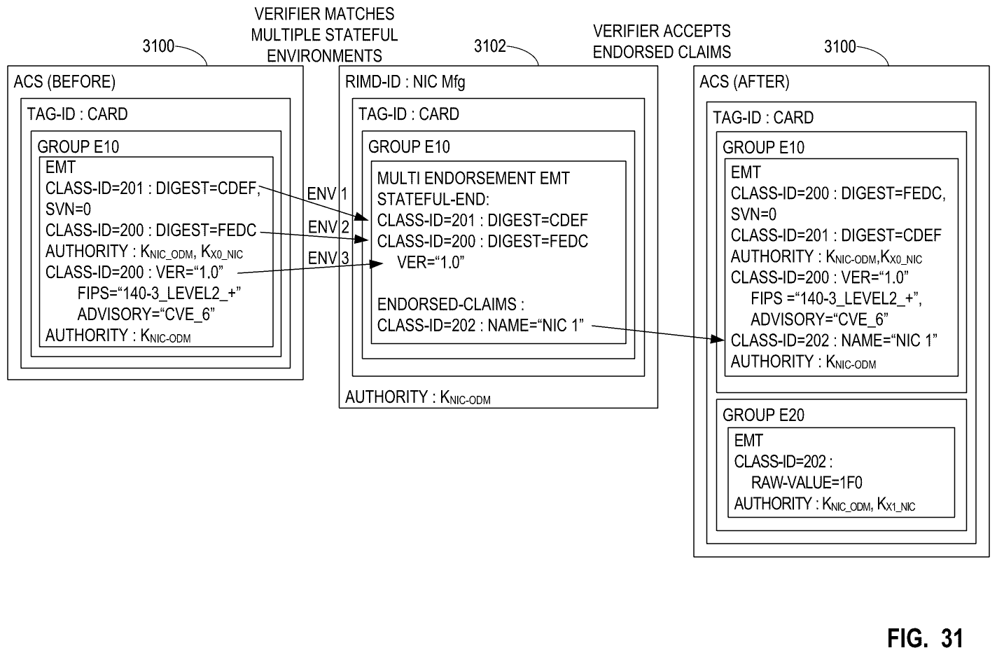

FIG. 32 illustrates an example ACS 3200 generated by the mesh verifier circuitry 300 of FIG. 3 for an attester for the example multi-endorsement use case of FIG. 31. The example ACS 3200 is the example ACS 3000 updated with the claims in the multi-endorsement EMT 3102.

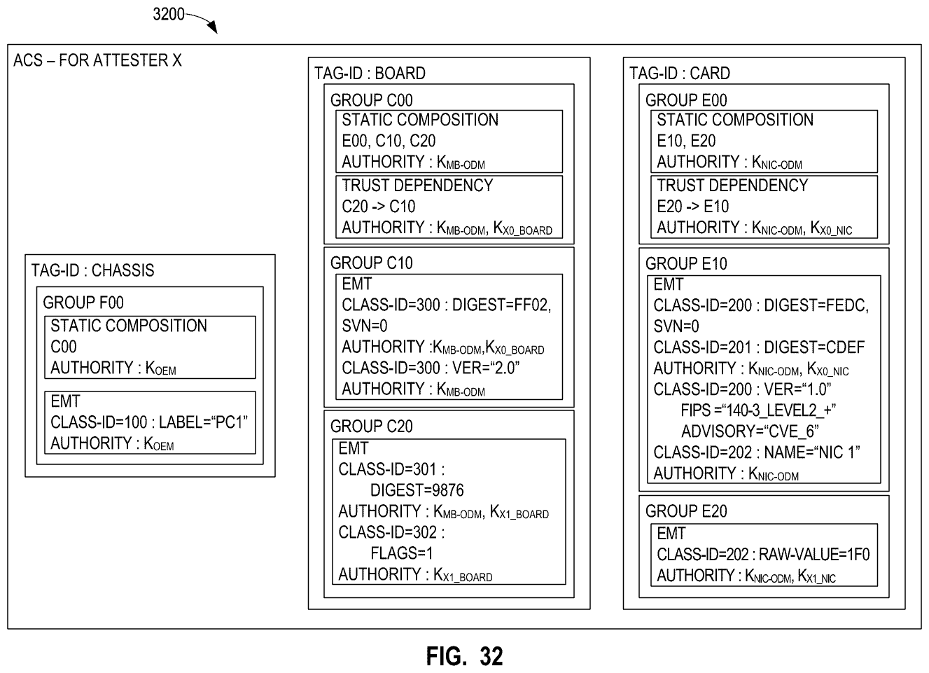

FIG. 33 illustrates an example NIC ACS 3300 generated by the mesh verifier circuitry 300 of FIG. 3 for a NIC of an attester for an example conditional endorsement with authority use case. The mesh verifier circuitry 300 matches environments and authorities contained in the NIC ACS 3300 with environments and authorities contained in a conditional endorsement 3302 from a manufacturer of the NIC. The mesh verifier circuitry 300 accepts the claims in the conditional endorsement 3302 into the NIC ACS 3300 because the environments and the authorities match.

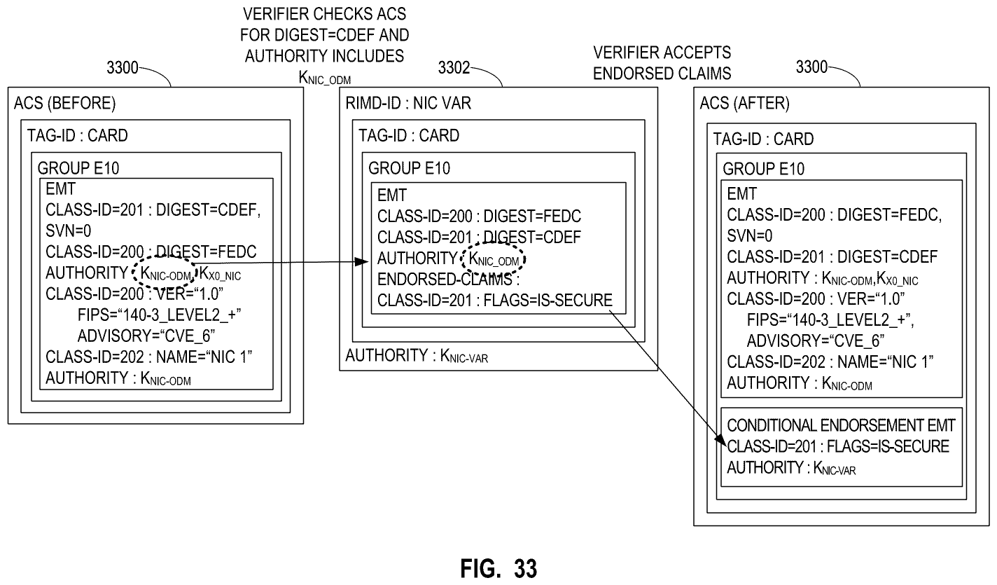

FIG. 34 illustrates an example ACS 3400 generated by the mesh verifier circuitry 300 of FIG. 3 for an attester for the example conditional endorsement with authority use case of FIG. 33. The example ACS 3400 is the example ACS 3200 updated with the claims in the conditional endorsement 3302.

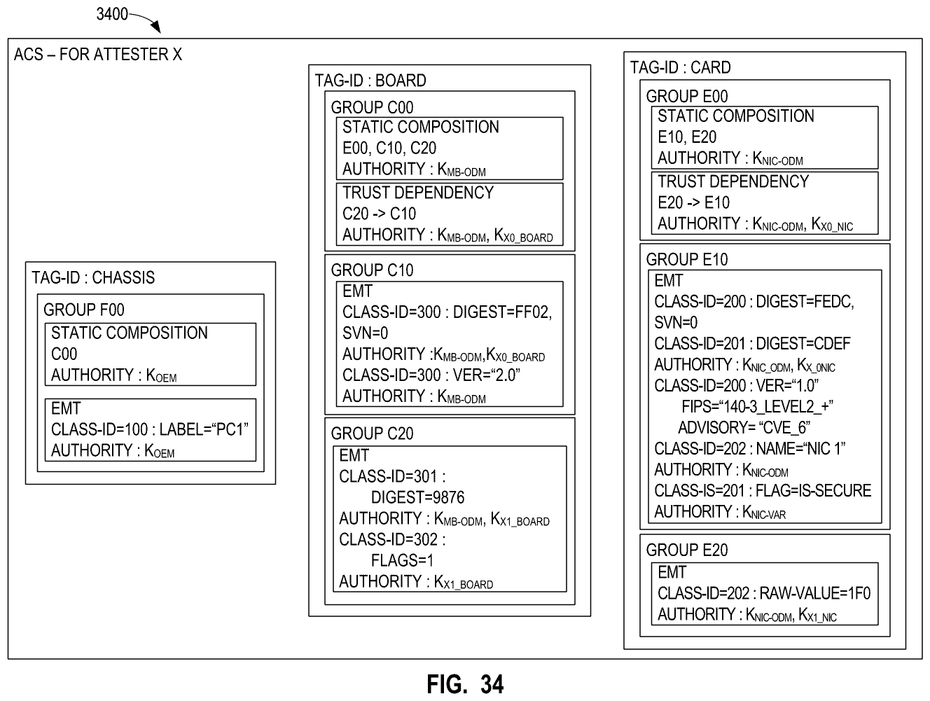

FIG. 35 illustrates example endorsements 3500 and reference values 3502 provided by an independent software vendor (ISV) for software of an attester and attestation evidence 3504 provided by the attester for an example concise SWID (CoSWID) matching use case. The mesh verifier circuitry 300 accepts CoSWID evidence 3502 from into the ACS 3500. The mesh verifier circuitry 300 matches reference values 3502 from the ISV to the ACS 3500 and accepts endorsements 3506 from the ISV into the ACS 3500.

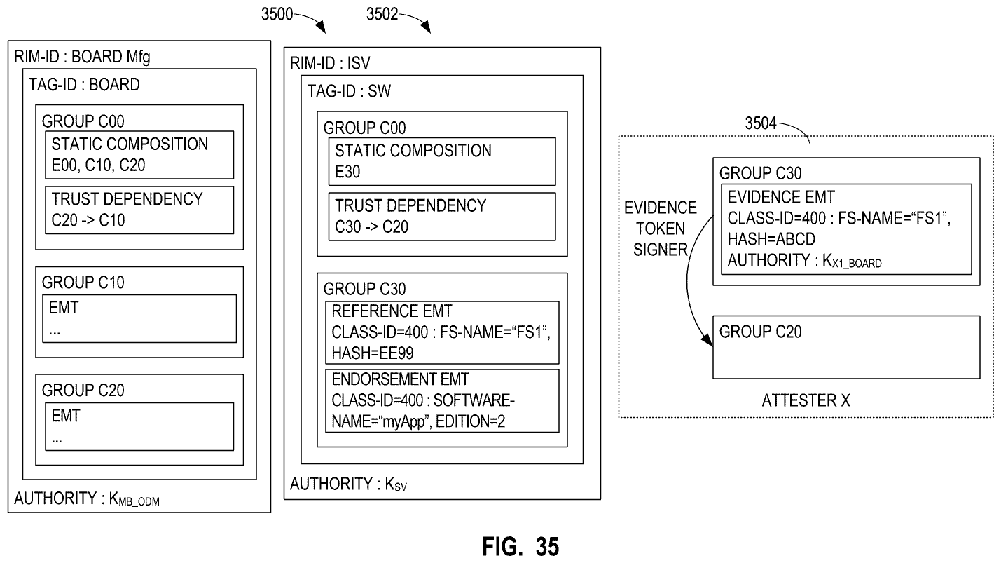

FIG. 36 illustrates an example ACS 3600 generated by the mesh verifier circuitry 300 of FIG. 3 for an attester for the example CoSWID matching use case of FIG. 35. The example ACS 3600 is the example ACS 3400 updated with the claims in the CoSWID evidence 3502, the reference values 3504 and the endorsements 3506.

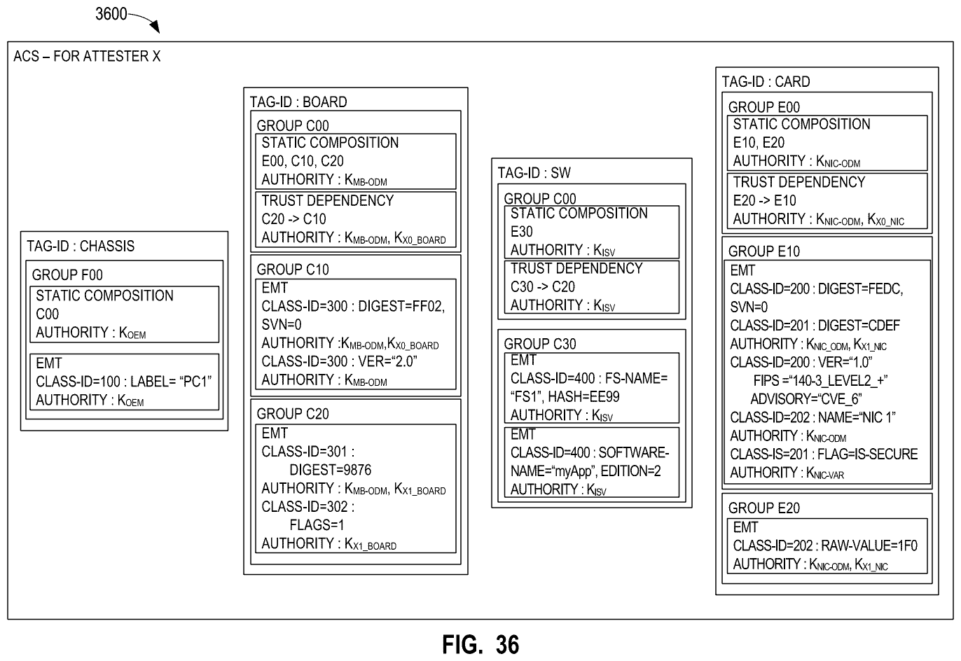

FIG. 37 illustrates an example ACS 3700 generated by the mesh verifier circuitry 300 of FIG. 3 for an attester after the mesh verifier circuitry 300 stages shown in FIGS. 17-36.

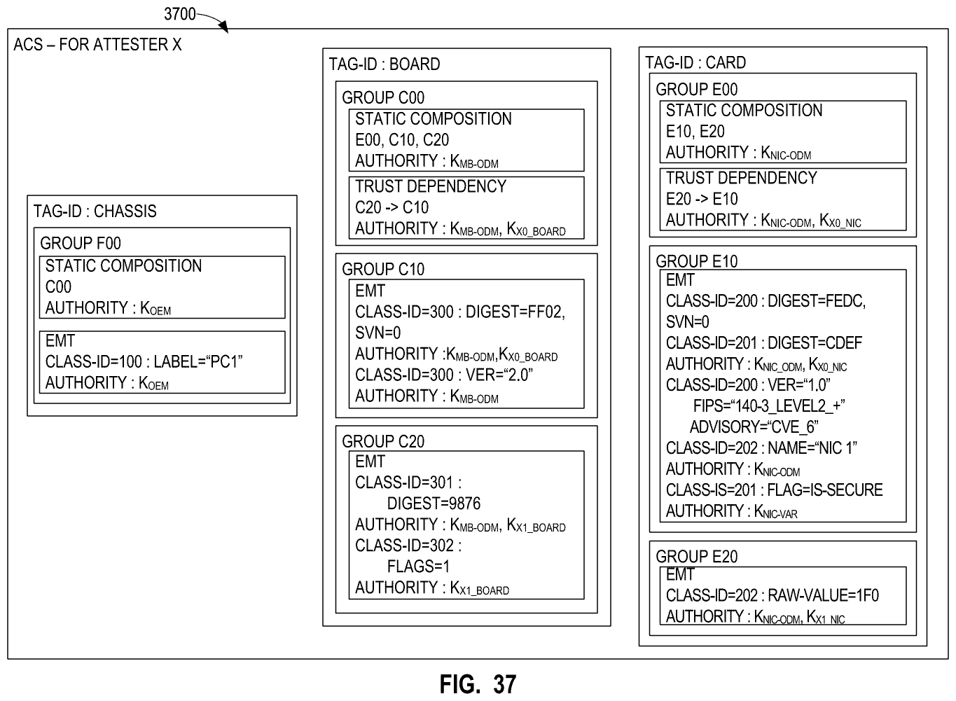

FIG. 38 illustrates an example an application of appraisal policy by the mesh verifier circuitry 300 to an ACS 3800.

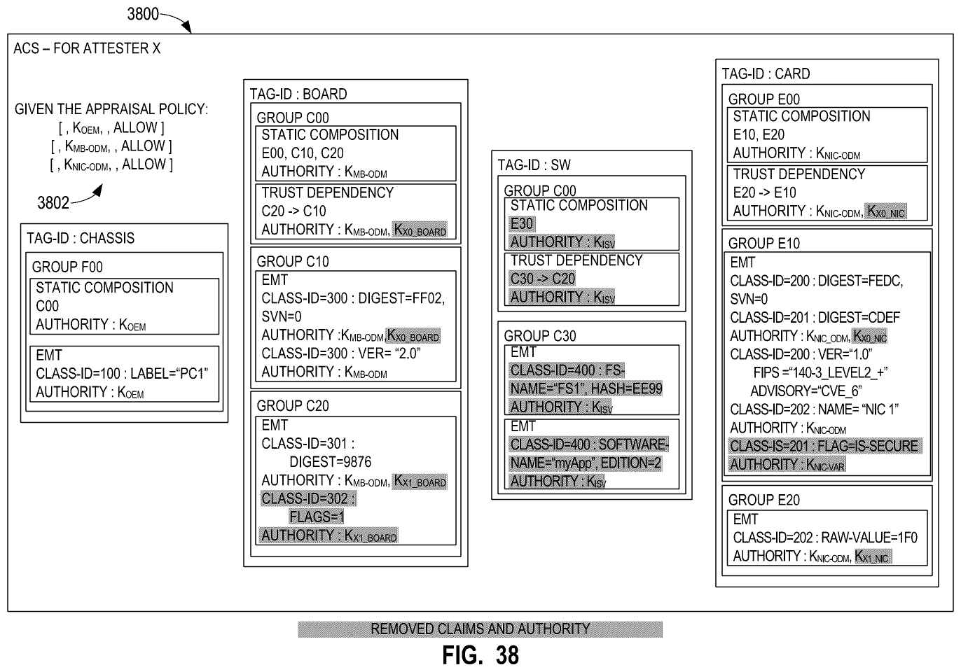

FIG. 39 illustrates an example ACS 3900 generated by the mesh verifier circuitry 300 of FIG. 3 for an attester after application of an appraisal policy. In the illustrated example of FIG. 39, the appraisal policy directs the mesh verifier circuitry 300 to remove claims and authority that are not associated with the authorities 3902.

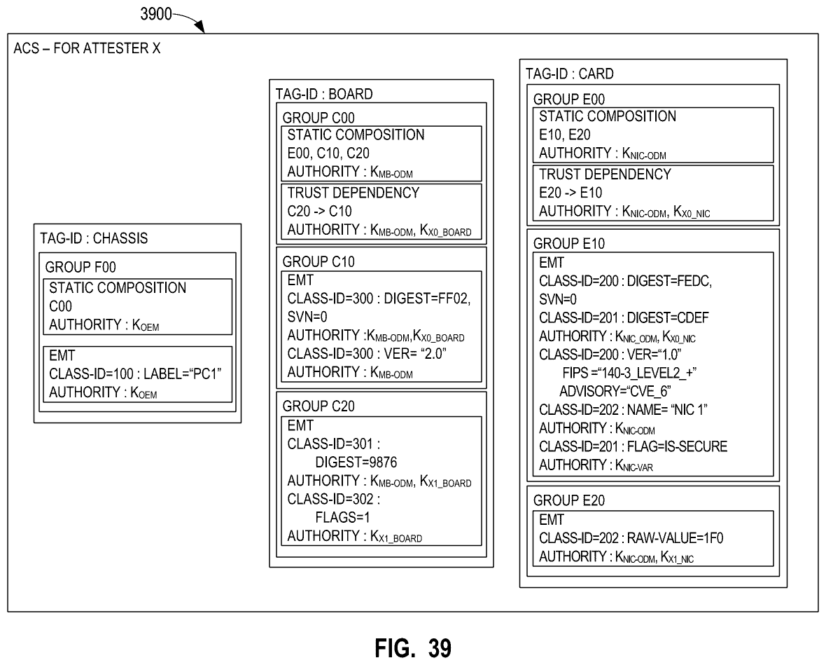

FIG. 40 illustrates example verifier asserted claims 4000 generated by the mesh verifier circuitry 300 of FIG. 3. Verifier asserted claims are claims made by the mesh verifier circuitry 300 about the attester. The verifier asserted claims include attestation results EMTs for the different groups in the ACS.

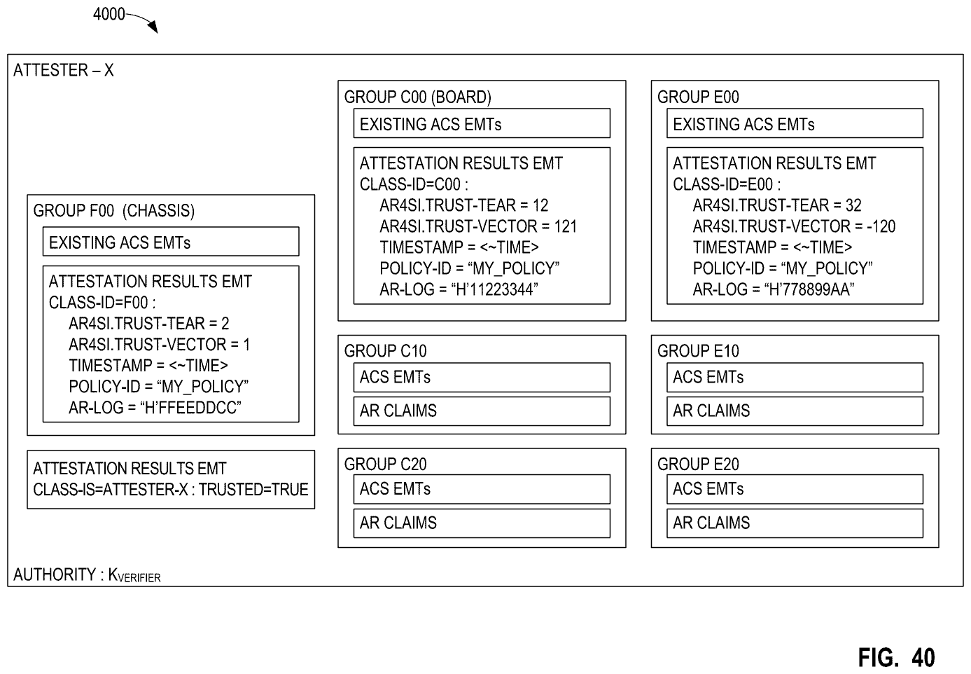

FIG. 41 illustrates an example final ACS 4100 generated by the mesh verifier circuitry 300 of FIG. 3 for an attester in a final state. The mesh verifier circuitry 300 generates attestation results for a relying party based on the final ACS 4100.

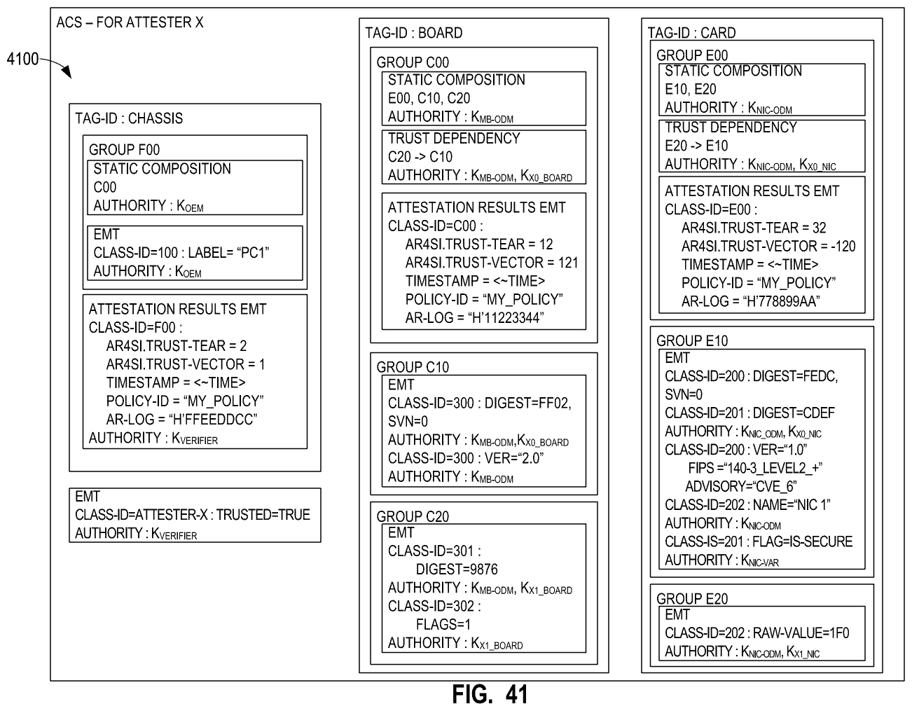

FIG. 42 illustrates an example system 4200 with appraisal contexts 4202.

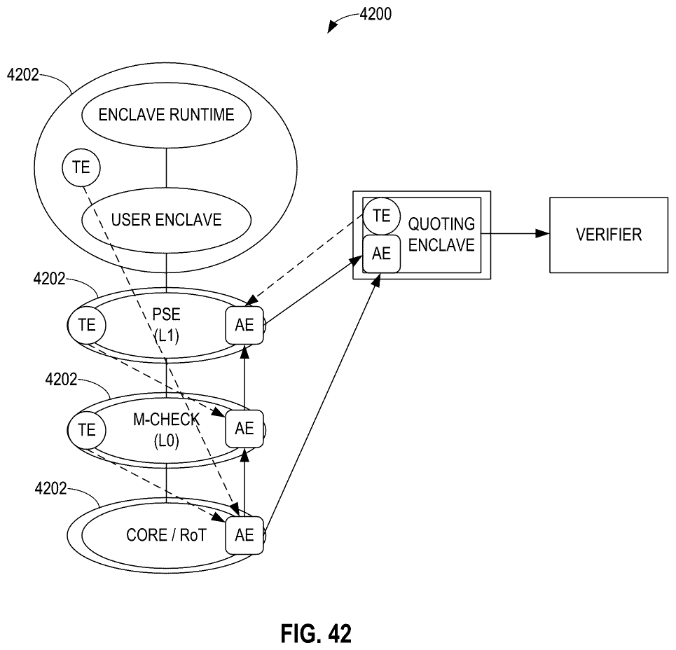

FIG. 43 is a block diagram of another example environment 4300 in which mesh verifier circuitry 300 operates to generate attestation results. The environment 4300 includes an attester 4302, a relying party 4304, a verifier 4306, an endorser 4308, and a reference value provider 4310. Each of the attester 4302, a relying party 4304, a verifier 4306, an endorser 4308, and a reference value provider 4310 provide and receive the same information as the attester 102, the relying party 104, the verifier 106, the endorser 108, and the reference value provider 110 of FIG. 1, respectively. The information shared between the attester 4302, a relying party 4304, a verifier 4306, an endorser 4308, and a reference value provider 4310 of FIG. 43 is formatted according to a Concise Reference Integrity Manifest (CoRIM) schema. CoRIM contains both reference values and endorsements.

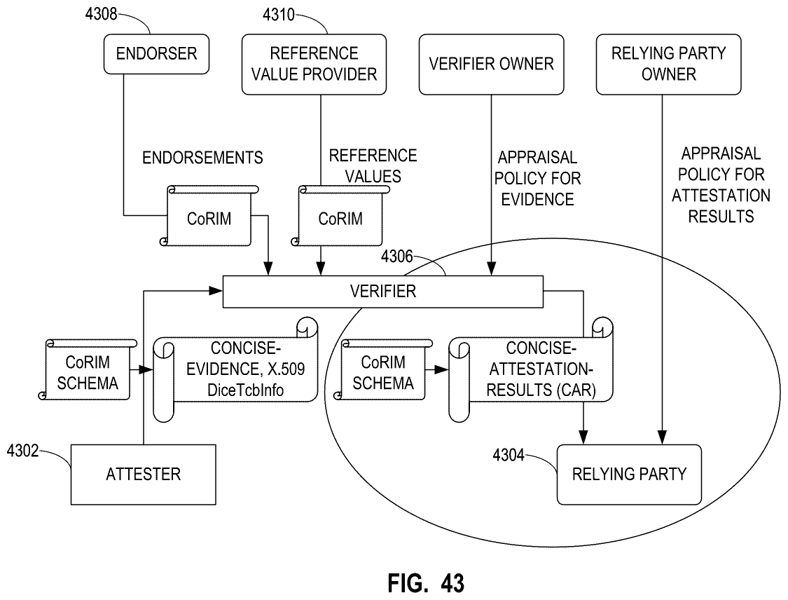

FIG. 44 is a block diagram illustrating attestation results utilizing attester compositional context. In order to implement a Concise Attestation Results (CAR) design, the verifier mesh 200 defines a new CoRIM tag type for Attestation Results: tagged-concise-ar-tag=#6.TBA (bytes .cbor concise-ar-tag); $concise-tag-type-choice/=tagged-concise-ar-tag. The verifier mesh 200 copies relevant verifier ACCEPTED-CLAIMS into the AR tag. The verifier mesh 200 originates AR claims. The verifier mesh 200 may assert new claims about the Attester (or any of its subcomponents): E.g.: AR4SI; AR4SI claims summarize the actual state of the Attester.

The verifier mesh 200 makes assumptions about the ACCEPTED-CLAIMS set: The Attester device composition is represented by ACCEPTED-CLAIMS; Only the current state of the Attester is represented; and Inputs to the Verifier that realized ACCEPTED-CLAIMS are available for logging/audit purposes and may be conveyed using a CAR tag.

CAR Schema: Concise-ar-tag; tag-id-identifies an instance of a CAR tag; profile—a profile identifier that qualifies ‘normal’ behavior; ar-triples—the triples that describe the current state of the Attester once appraisal is complete. ar-triples are a subset of CoRIM triples.

concise-ar-tag={&(tag-id: 0)=>tag-identity-map;? &(profile: 1)=>$profile-type-choice; &(ar-triples: 2)=>ar-triples-map; *$$concise-ar-tag-extension.

The AR4SI I-D suggests the trustworthiness of the Verifier is important to the Relying Party and that this is achieved through evaluation of the Verifier's software. The ‘concise-evidence’ schema can be used to satisfy this requirement. The verifier can bundle Evidence and Attestation Results in a common Conceptual Message.

CoMID triples as Attestation Results (a.k.a., ar-triples-map): endorsed-triples—The Verifier's ACCEPTED-CLAIMS set. Contains Attester current state; dependency-triples—ACCEPTED-CLAIMS set may have trust dependencies that have been verified; membership-triples—ACCEPTED-CLAIMS set may describe Attester composition. Membership captures the composition hierarchy.

On-the-fence triples; coswid-triples—Software packages that are installed on a target environment are described using coswid.

AR Claims include claims made by the verifier and AR4SI claims. The Verifier may assert claims about the Attester: The CoMID ‘measurement-values-map’ is extended to include AR4SI claims. The Verifier creates claims under its own authority. The appraisal log is a claim about appraisal integrity. AR4SI claims can be asserted within the appropriate grouping context);

AR4SI Claims include: timestamp—the time the Verifier asserted AR4SI claims; status—the ar4si trust tier (none, affirming, warning, contraindicated). A trust tier status is applied to the top of a composition hierarchy. It aggregates status derived from the status of each of its sub-components.; trust-vector—the ar4si trust vector—a codepoint from −128 to 127 describing a results condition; and policy-id—the appraisal policies used by the Verifier; ar-log—proof of appraisal integrity

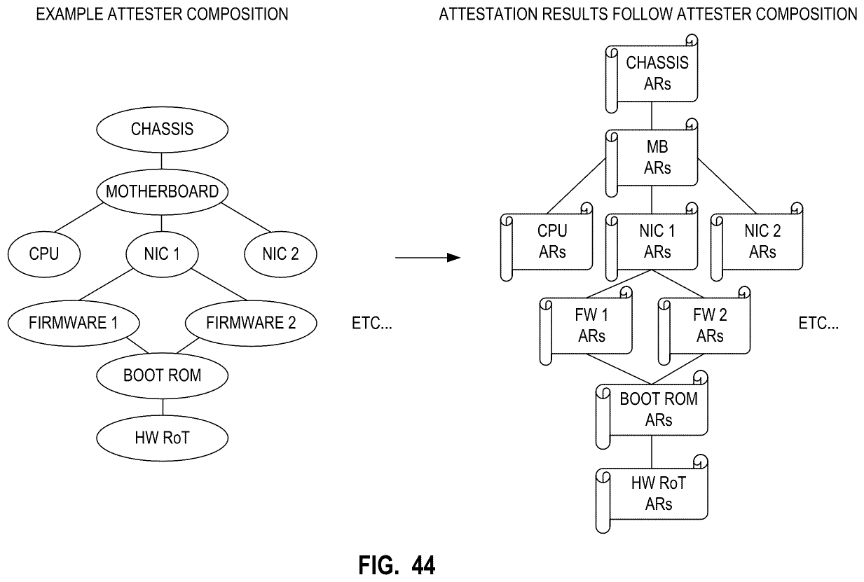

FIG. 45 shows the CAR schema in concise data definition language (CDDL). The following is an example of Common AR4SI schema: $ar4si.trust-tier/=ar4si.trust-tier-none; $ar4si.trust-tier/=ar4si.trust-tier-affirming; $ar4si.trust-tier/=ar4si.trust-tier-warning; $ar4si.trust-tier/=ar4si.trust-tier-contraindicated; ar4si.trust-tier-none=0; ar4si.trust-tier-affirming=2; ar4si.trust-tier-warning=32; ar4si.trust-tier-contraindicated=96; ar4si.trustworthiness-vector=non-empty<{? instance-identity=>$ar4si.trustworthiness-claim; ? configuration=>$ar4si.trustworthiness-claim;? executables=>$ar4si.trustworthiness-claim; ? file-system=>$ar4si.trustworthiness-claim; ? hardware=>$ar4si.trustworthiness-claim; ? runtime-opaque=>$ar4si.trustworthiness-claim; ? storage-opaque=>$ar4si.trustworthiness-claim; ? sourced-data=>$ar4si.trustworthiness-claim}>; $ar4si.trustworthiness-claim=−128 . . . 127.

Conditional endorsement triple: conditional-endorsement-triple-record=[stateful-environment-record; endorsed values; measurement-values-map]; stateful-environment-record=[environment-map, measurement-map].

Conditional endorsement series triple: conditional-endorsement-series-triple-record=[stateful-environment-record; order matters: the first matching record wins and halts matching; [+conditional-series-record]]; stateful-environment-record=[environment-map, measurement-map]; conditional-series-record=[; reference values to be matched against evidence; refv: measurement-values-map; endorsed values that apply in case revf matches; endv: measurement-values-map].

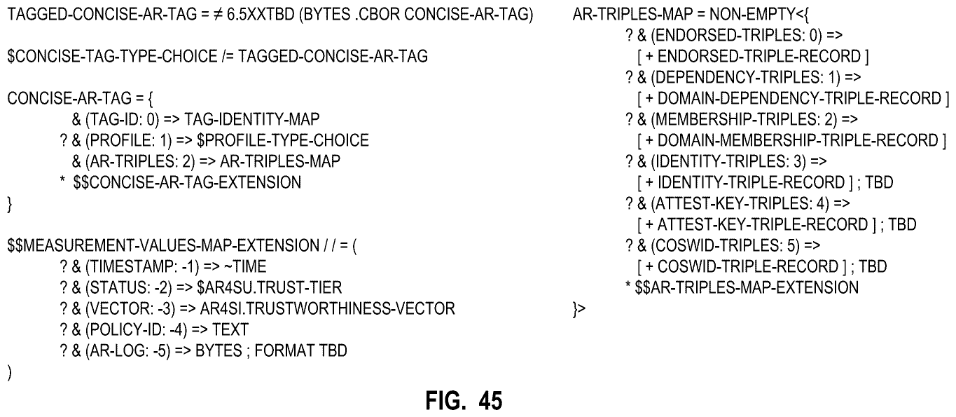

FIG. 46 illustrates an ACS 4600 generated by the verifier mesh 200 as a common oracle for multiple attestation formats. A relying party may request attestation results in a variety of attestation formats. In the illustrated example, attestation results are generated from the ACS 4600 as any of JWT, CMS, XML, CWT, and/or X.509. In other examples, attestation results may be generated in additional formats not shown in FIG. 46.

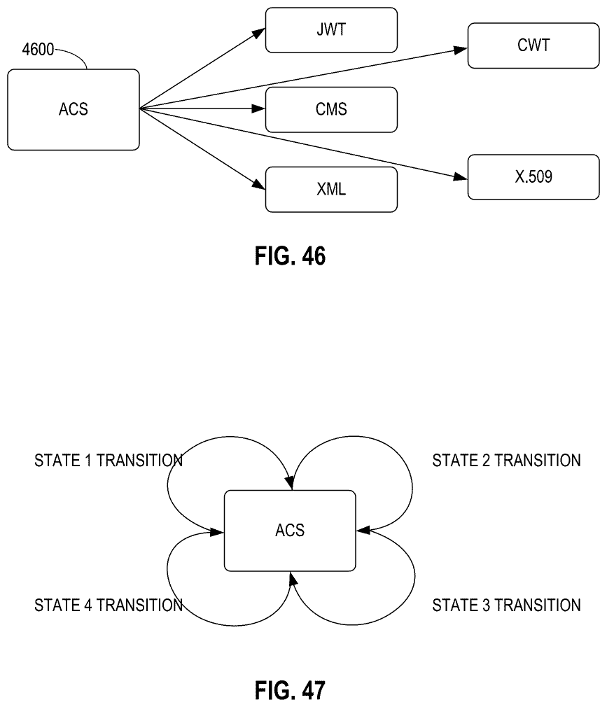

FIG. 47 is a diagram illustrating transition stages of an ACS 4700 to ensure processing accuracy and consistency. In the illustrated example of FIG. 47, there are four stages. In other examples, ACS 4700 may undergo fewer (e.g., one, two, three) stages or more (e.g., 5, 10, etc.) stages.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable a mesh of verifiers to cooperatively produce a detailed representation of an operating state of an attester device to generate reliable attestation results from attestation evidence, reference values, and endorsements in various formats, without concern for timing and ordering of the attestation information. Examples disclosed herein generates ACSs for use as an attestation-based content-defined network. Example systems, apparatus, articles of manufacture, and methods disclosed herein improve the efficiency of a computing device by enabling parallel contribution to ACSs by multiple nodes in a mesh, reducing computational requirements for individual nodes in the mesh. Examples disclosed herein further improve the efficiency of a computing device by synchronizing ACSs across the nodes of the mesh, reducing redundancies in the computations performed by mesh nodes.

Example systems, apparatus, articles of manufacture, and methods disclosed herein extract appraisal context information from attestation evidence, reference values, and endorsements to generate appraisal context metadata for use in generation of networks of nodes. Example systems, apparatus, articles of manufacture, and methods disclosed herein generate networks of nodes combining top down and bottom up descriptions of an operating state of an attester device to generate attestation results. Disclosed systems, apparatus, articles of manufacture, and methods improve the efficiency of using a computing device by generating a topological description of the attester using appraisal context information, reducing computational waste by preventing redundant requests for information from the attester and/or suppliers. Disclosed systems, apparatus, articles of manufacture, and methods are accordingly directed to one or more improvement(s) in the operation of a machine such as a computer or other electronic and/or mechanical device.

Further examples and combinations thereof include the following:

Example 1 includes at least one non-transitory machine-readable medium comprising machine-readable instructions to cause at least one processor circuit to at least: obtain an attestation input including an accepted claims set (ACS) of a verifier mesh and attestation evidence indicative of a claimed operating state of an attester, the verifier mesh including a plurality of verifiers; update the ACS based on the attestation evidence; and cause the ACS to be transmitted to the plurality of verifiers in the verifier mesh.

Example 2 includes the storage medium of example 1, wherein the ACS is append-only.

Example 3 includes the storage medium of any of examples 1 or 2, wherein the ACS is a shared ACS, and the plurality of verifiers use distributed ledger technology to synchronize the shared ACS across the verifier mesh, the shared ACS is an ACS ledger, and the instructions are to cause one or more of the at least one processor circuit to update the ACS ledger by posting an ACS record to the ACS ledger.

Example 4 includes the storage medium of any of examples 1-3, wherein the ACS is a shared ACS and the instructions are to cause one or more of the at least one processor circuit to periodically synchronize the shared ACS across the verifier mesh based on a synchronization protocol or a consensus protocol.

Example 5 includes the storage medium of any of examples 1-4, wherein the instructions are to cause one or more of the at least one processor circuit to obtain the attestation input within a defined quantum window using a synchronized clock, epoch beacon, time service, or bundling service to synchronize the plurality of verifiers in the verifier mesh, each verifier of the plurality of verifiers in the verifier mesh to process attestation inputs obtained within the defined quantum window.

Example 6 includes the storage medium of any of examples 1-5, wherein the ACS is a first partial ACS generated by a first verifier of the verifier mesh, the attestation input further includes a second partial ACS generated by a second verifier of the verifier mesh, and the instructions are to cause one or more of the at least one processor circuit to update the shared ACS based on the first partial ACS and the second partial ACS.

Example 7 includes the storage medium of any of examples 1-6, wherein each verifier of the plurality of verifiers produces an identical ACS given the same attestation input.

Example 8 includes the storage medium of any of examples 1-7, wherein the instructions are to cause one or more of the at least one processor circuit to: obtain an appraisal policy from a relying party; and generate attestation results based on the ACS and the appraisal policy.

Example 9 includes the storage medium of any of examples 1-8, wherein the ACS is an attestation-based content-defined network and the appraisal policy describes a view of the ACS that contains claim sets of the ACS that the relying party identifies as interesting.

Example 10 includes the storage medium of any of examples 1-9, wherein the ACS is obtained from a first verifier of the verifier mesh via a conceptual message wrapper message.

Example 11 includes an apparatus including machine-readable instructions; and at least one processor circuit to be programmed by the machine-readable instructions to: obtain an attestation input including a first accepted claims set (ACS) of a verifier mesh and attestation evidence indicative of a claimed operating state of an attester, the verifier mesh including a plurality of verifiers; generate a second ACS based on the first ACS and the attestation evidence; and cause the second ACS to be transmitted to the plurality of verifiers in the verifier mesh.

Example 12 includes the apparatus of example 11, wherein a plurality of ACSs are synchronized across the verifier mesh according to distributed ledger technology, one or more of the at least one processor circuit to post a record of the second ACS to an ACS ledger shared by the plurality of verifiers.

Example 13 includes the apparatus of any of examples 11 or 12, wherein one or more of the at least one processor circuit is to periodically transmit the second ACS to the plurality of verifiers based on a synchronization protocol or a consensus protocol.

Example 14 includes the apparatus of any of examples 11-13, wherein one or more of the at least one processor circuit is to obtain the attestation input within a defined quantum window defined according to a clock, epoch beacon, time service, or bundling service to synchronize the plurality of verifiers.

Example 15 includes the apparatus of any of examples 11-14, wherein one or more of the at least one processor circuit is to: obtain an appraisal policy from a relying party; and generate attestation results based on the second ACS and the appraisal policy.

Example 16 includes the apparatus of any of examples 11-15, wherein the second ACS is an attestation-based content-defined network and the appraisal policy describes a view of the second ACS that contains claim sets of the second ACS the relying party identifies as interesting.

Example 17 includes a method including obtaining an attestation input including a first accepted claims set (ACS) of a verifier mesh and attestation evidence indicative of a claimed operating state of an attester, the verifier mesh including a plurality of verifiers; and generating a second ACS based on the first ACS and the attestation evidence; and causing the second ACS to be transmitted to the plurality of verifiers in the verifier mesh.

Example 18 includes the method of example 17, wherein the attestation input is obtained within a defined quantum window defined by a synchronized clock, epoch beacon, time service, or bundling service shared by the plurality of verifiers in the verifier mesh, each verifier of the plurality of verifiers in the verifier mesh to process attestation inputs obtained within the defined quantum window.

Example 19 includes the method of any of examples 17 or 18, wherein the attestation input is a first attestation input, further including: obtaining a second attestation input including a third ACS of the verifier mesh; and generating a fourth ACS based on the second attestation input.

Example 20 includes the method of any of examples 17-19, wherein an order in which the first attestation input and the second attestation input are obtained does not affect the fourth ACS that is generated.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions to cause at least one processor circuit to at least:
obtain an attestation input including an accepted claims set (ACS) of a verifier mesh and attestation evidence indicative of a claimed operating state of an attester, the verifier mesh including a plurality of verifiers;
update the ACS based on the attestation evidence; and
cause the ACS to be transmitted to the plurality of verifiers in the verifier mesh.

2. The at least one non-transitory machine-readable medium of claim 1, wherein the ACS is append-only.

3. The at least one non-transitory machine-readable medium of claim 1, wherein the ACS is a shared ACS, and the plurality of verifiers use distributed ledger technology to synchronize the shared ACS across the verifier mesh, the shared ACS is an ACS ledger, and the instructions are to cause one or more of the at least one processor circuit to update the ACS ledger by posting an ACS record to the ACS ledger.

4. The at least one non-transitory machine-readable medium of claim 1, wherein the ACS is a shared ACS and the instructions are to cause one or more of the at least one processor circuit to periodically synchronize the shared ACS across the verifier mesh based on a synchronization protocol or a consensus protocol.

5. The at least one non-transitory machine-readable medium of claim 1, wherein the instructions are to cause one or more of the at least one processor circuit to obtain the attestation input within a defined quantum window using a synchronized clock, epoch beacon, time service, or bundling service to synchronize the plurality of verifiers in the verifier mesh, each verifier of the plurality of verifiers in the verifier mesh to process attestation inputs obtained within the defined quantum window.

6. The at least one non-transitory machine-readable medium of claim 1, wherein the ACS is a first partial ACS generated by a first verifier of the verifier mesh, the attestation input further includes a second partial ACS generated by a second verifier of the verifier mesh, and the instructions are to cause one or more of the at least one processor circuit to update the shared ACS based on the first partial ACS and the second partial ACS.

7. The at least one non-transitory machine-readable medium of claim 1, wherein each verifier of the plurality of verifiers produces an identical ACS given the same attestation input.

8. The at least one non-transitory machine-readable medium of claim 1, wherein the instructions are to cause one or more of the at least one processor circuit to:
obtain an appraisal policy from a relying party; and
generate attestation results based on the ACS and the appraisal policy.

9. The at least one non-transitory machine-readable medium of claim 8, wherein the ACS is an attestation-based content-defined network and the appraisal policy describes a view of the ACS that contains claim sets of the ACS that the relying party identifies as interesting.

10. The at least one non-transitory machine-readable medium of claim 1, wherein the ACS is obtained from a first verifier of the verifier mesh via a conceptual message wrapper message.

11. An apparatus comprising:
machine-readable instructions; and
at least one processor circuit to be programmed by the machine-readable instructions to:
obtain an attestation input including a first accepted claims set (ACS) of a verifier mesh and attestation evidence indicative of a claimed operating state of an attester, the verifier mesh including a plurality of verifiers;
generate a second ACS based on the first ACS and the attestation evidence; and
cause the second ACS to be transmitted to the plurality of verifiers in the verifier mesh.

12. The apparatus of claim 11, wherein a plurality of ACSs are synchronized across the verifier mesh according to distributed ledger technology, one or more of the at least one processor circuit to post a record of the second ACS to an ACS ledger shared by the plurality of verifiers.

13. The apparatus of claim 11, wherein one or more of the at least one processor circuit is to periodically transmit the second ACS to the plurality of verifiers based on a synchronization protocol or a consensus protocol.

14. The apparatus of claim 11, wherein one or more of the at least one processor circuit is to obtain the attestation input within a defined quantum window defined according to a clock, epoch beacon, time service, or bundling service to synchronize the plurality of verifiers.

15. The apparatus of claim 11, wherein one or more of the at least one processor circuit is to:
obtain an appraisal policy from a relying party; and
generate attestation results based on the second ACS and the appraisal policy.

16. The apparatus of claim 15, wherein the second ACS is an attestation-based content-defined network and the appraisal policy describes a view of the second ACS that contains claim sets of the second ACS the relying party identifies as interesting.

17. A method comprising:
obtaining an attestation input including a first accepted claims set (ACS) of a verifier mesh and attestation evidence indicative of a claimed operating state of an attester, the verifier mesh including a plurality of verifiers; and
generating a second ACS based on the first ACS and the attestation evidence; and
causing the second ACS to be transmitted to the plurality of verifiers in the verifier mesh.

18. The method of claim 17, wherein the attestation input is obtained within a defined quantum window defined by a synchronized clock, epoch beacon, time service, or bundling service shared by the plurality of verifiers in the verifier mesh, each verifier of the plurality of verifiers in the verifier mesh to process attestation inputs obtained within the defined quantum window.

19. The method of claim 17, wherein the attestation input is a first attestation input, further including:
obtaining a second attestation input including a third ACS of the verifier mesh; and
generating a fourth ACS based on the second attestation input.

20. The method of claim 19, wherein an order in which the first attestation input and the second attestation input are obtained does not affect the fourth ACS that is generated.
